(19) United States
(12) Patent Application Publication
(10) Pub. No.: US 2026/0059218 A1
(43) Pub. Date: Feb. 26, 2026

(54) SYSTEM AND METHOD FOR DETERMINING STATE OF CHARGE OF BATTERIES IN WIRELESS AUDIO PRODUCTS

(71) Applicant: Harman International Industries, Incorporated, Stamford, CT (US)

(72) Inventors: Yi Zhang, Shenzhen, Guangdong (CN); Eric CAI, Shenzhen, Guangdong (CN)

(21) Appl. No.: 19/103,205

(22) PCT Filed: Oct. 14, 2022
(86) PCT No.: PCT/US2022/078154

§ 371 Date: Feb. 11, 2025

(51) Int. Cl. H04R 1/10; H02J 7/00; H04R 29/00

(52) U.S. Cl. CPC H04R 1/1025; H02J 7/0036; H02J 7/0044; H02J 7/0049; H02J 7/007194; H04R 1/1091; H04R 29/002; H04R 2420/07

(57) ABSTRACT

Various systems and methods are provided for monitoring state of charge (SOC) of wireless headphones. In one embodiment, a method comprises initializing a state of charge (SOC) of the earbud battery based on battery voltage in response to transitioning from a non-charging mode to a charging mode of the wireless earbud. In another embodiment, a first system comprises a left earbud, a right earbud, and a charging case comprising a microcontroller unit that monitors a right earbud battery and a left earbud battery via the charging case. In another embodiment, a second system comprises a left earbud, a right earbud, and a charging case comprising at least one communication bus communicatively coupled to the left earbud and right earbud to compare and correct a total charge of the left earbud battery, the right earbud battery, and/or the charging case battery.

### FIELD

This disclosure relates to monitoring and control of battery operation in wireless headphone devices.

### BACKGROUND

Wearable products, such as Bluetooth True Wireless (TWS) headphones, are popular amongst consumers. The quality of the user experience when listening to music, phone calls, and the like via Bluetooth TWS headphones is increased compared to traditional wired headphones. There is a strong demand amongst users for TWS headphones with fast charging capabilities. However, introducing fast charging capabilities into the current technology may introduce issues in existing components of the technology. In particular, the ability of the current technology to accurately determine and indicate remaining battery power capacity may be hindered, which may result in inaccurate values of the remaining batter power capacity being displayed to the user.

Existing solutions, such as fuel gauge integrated circuit (IC), ADC (analog to digital converter) reading battery voltage, and the like, that determine and indicate battery power capacity of headphones may not be applicable to true wireless (TWS) headphones. Specifically, the feasibility of the existing solutions may be hindered by increased upfront costs for additional hardware components, such as additional fuel gauge ICs, printed circuit board (PCB) space, and the like. Additionally, the ADC reading battery voltage solution may not accurately consider temperature effects of fast charging on determining and indicating battery power capacity, which may decrease the accuracy of indicating battery power capacity. Further, the voltage read via the ADC reading battery voltage solution is not the actual battery voltage. Internal impedance of the battery at high charge or discharge currents may result in deviations in value between the voltage read via the ADC reading battery solution and the actual battery voltage. As such, the existing solutions may not address the accuracy issues associated with fast charging capabilities of wireless headphones. Such issues have been recognized by the inventors herein.

### SUMMARY

In one approach, initializing a state of charge (SOC) of the earbud battery based on battery voltage in response to transitioning from a non-charging mode to a charging mode of the wireless earbud may be utilized to simulate the fuel gauge IC at various temperatures, charge currents, and discharge currents and increase the accuracy of indicating battery power capacity during fast-charging capabilities. The charging mode may comprise supplying a charge current to a left earbud battery and/or to a right earbud battery. The non-charging mode may comprise one or more of supplying a discharge current to the left earbud battery or to the right earbud battery, entering and maintaining a passive state of the left earbud battery or the right earbud battery, and a leakage current wherein a flow of current occurs during the passive state.

In an example, a processor, such as a Bluetooth chipset or microcontroller unit (MCU), may be utilized to simulate the fuel gauge IC at various temperatures, charge currents, and discharge currents via instructions configured, stored, and executed in at least one memory. In this way, the state of charge (SOC) of an earbud of wireless headphones may be determined during a charging mode of an earbud battery and non-charging mode of an earbud battery with acceptable accuracy without incurring upfront costs. Additionally, temperature effects on SOC of the earbud battery may be considered during the charge and non-charging modes of the earbud battery.

A charging case of the wireless headphones may comprise the microcontroller unit (MCU) whereas an earbud may comprise the Bluetooth chipset. In this way, the charging case and the earbud may independently determine an open circuit voltage (OCV) and accordingly, a state of charge (SOC) of the earbud battery. The open circuit voltage (OCV) may be determined by modeling the earbud battery based on a first order resistor-capacitor (RC) circuit with charging parameters and corrections of the charge current (e.g., during the charging mode), and discharging parameters (e.g., during the non-charging mode). The state of charge (SOC) of the earbud battery may be determined via pre-determined experimental data from pre-constructed state of charge-open circuit voltage (SOC-OCV) curves and the determined open-circuit voltage.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a schematic of a wireless headphone charging system;

FIG. 2 shows a block diagram including various components of a wireless headphone;

FIG. 3 shows an example of a battery of a wireless headphone;

FIGS. 4A, 4B, and 4C show graphs utilized in the construction of a state of charge-open circuit voltage (SOC-OCV) curve;

FIG. 5 shows a schematic of a battery model;

FIG. 6 shows a block diagram of a control scheme for an earbud battery;

FIG. 7 shows a flow diagram of pre-determined instructions implemented by a Bluetooth Chipset or MCU;

FIG. 8 shows a flow diagram of a charging scheme for a left earbud and right earbud located in a charging case during a charging mode;

FIG. 9 shows a flow diagram of a discharging scheme for a left earbud and a right earbud during a non-charging mode;

FIG. 10 shows a timing diagram for a charging case, a left ear bud, and a right earbud during a charging mode; and

FIG. 11 shows a timing diagram for a left earbud and a right earbud during a non-charging mode.

### DETAILED DESCRIPTION

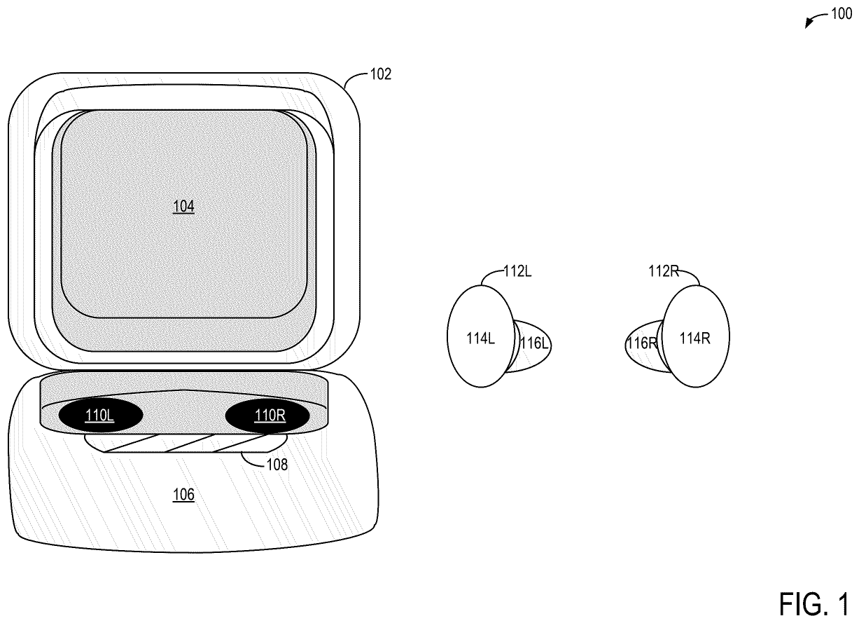

The disclosure provides for systems and methods that address the above-described issues that may arise when implementing fast charging capabilities in wireless headphones. FIG. 1 illustrates a wireless headphone charging system 100 including in-ear headphones, earphones, and earbuds. It may be understood that an earbud is one non-limiting example of an earphone according to the present disclosure. Other embodiments of the present disclosure may include earphones or headphones located on or over the ear of a user, and the like.

The wireless headphone charging system 100 may comprise a charging case 102, a left earbud 112L, and a right earbud 112R. The charging case 102 may comprise a case top 104 and a case bottom 106. The case bottom 106 may include a button 108, a left cavity 110L, and a right cavity 110R. The button 108 may display the charge level of the charging case 102 in addition to syncing electronic devices, such as cellular phones, computers, and the like, to the wireless headphones via Bluetooth. The left cavity 110L and the right cavity 110R may include a plurality of charging pins wherein electrical power is supplied during a charging mode of the left earbud 112L and the right earbud 112R. The charging pins may be protruding from elevated platforms located in the left cavity 110L and the right cavity 110R. Docking magnets may be adjacent to the charging pins, enabling the left earbud 112L and the right earbud 112R to dock within the left cavity 110L and right cavity 110R, respectively.

In other embodiments of the present disclosure, electrical power may be supplied to the charging case 102 via alternative components, such as charging contacts, and the like. Electrical current entering/exiting the battery may be determined using the battery models described herein. Additionally, the docking magnets may be located in different locations relative to an electrical power supply location. In some embodiments of the present disclosure, electrical power may be supplied to the charging case 102 via an external power source via wiring, wireless charger pads, and the like.

The left earbud 112L and the right earbud 112R may comprise a body 114L and a body 114R in addition to an ear tip 116L and ear tip 116R. The body 114L and the body 114R house various components of the left earbud 112L and the right earbud 112R, including a battery, a microphone, a Bluetooth chipset and/or MCU, and the like. The ear tip 116L and ear tip 116R may be coupled to the body 114L and the body 114R accordingly. Additionally, the ear tip 116L and ear tip 116R may be inserted into an ear of a user to position the left earbud 112L and the right earbud 112R. Further, the left earbud 112L and the right earbud 112R may include charging contacts. In some embodiments of the present disclosure, the left earbud 112L and the right earbud 112R may include docking magnets that orient the earbuds via the charging contacts in the left cavity 110L and the right cavity 110R of the charging case 102. In this way, electrical power may be supplied to the left earbud 112L and the right earbud 112R to charge the earbuds.

It may be understood that the examples provided are illustrative rather than absolute. Other embodiments of the present disclosure may include additional or alternative components, alternative configurations of the aforementioned components, and alternative functions of the aforementioned components without departing from the scope of the disclosure.

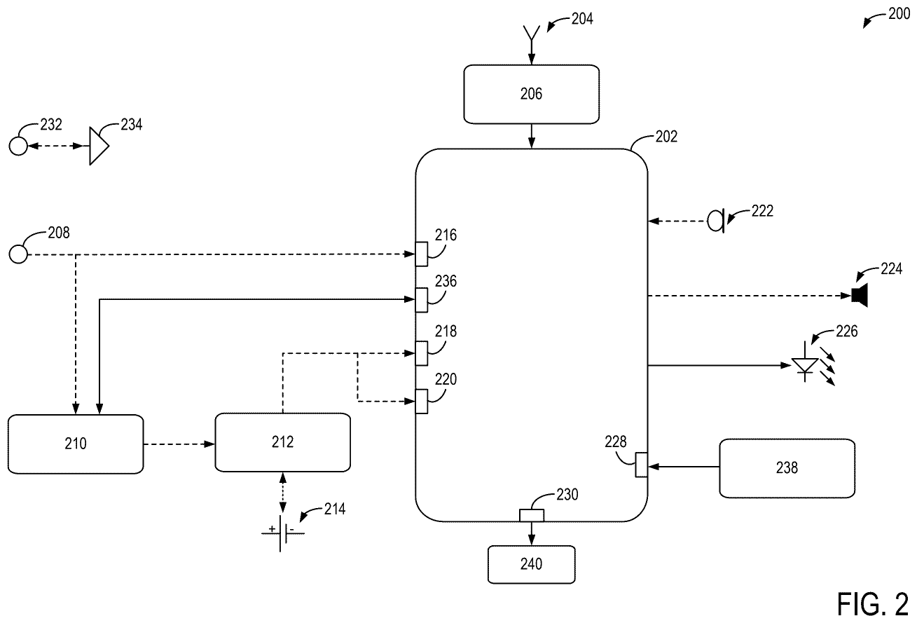

Hardware and other various components of a wireless headphone 200 are shown in FIG. 2. The wireless headphone 200 may comprise a Bluetooth chipset 202, a Bluetooth antenna 204, a radio frequency (RF) filter 206, a charge integrated circuit (IC) 210, a protection integrated circuit (IC) 212, a battery 214, a microphone 222, a loudspeaker 224, a light emitting diode (LED) 226, a tap touch integrated circuit (IC) 238, and a temperature sensor 240. The wireless headphone may include a plurality of integrated circuits, including the charge IC 210, the protection IC 212, and the tap touch IC 238. The wireless headphone 200 may further comprise a plurality of communication channels wherein various types of signals may travel to communicate information to and from the Bluetooth chipset 202. In one embodiment of the present disclosure, audio signals indicated by dashed lines, power signals indicated by dotted lines, and control signals indicated by solid lines may travel via the plurality of communication channels to and from the Bluetooth chipset 202.

Electric power may be supplied to the wireless headphone 200 via terminal 208 via an external power source. The external power source may be supplied via a charging case (e.g., charging case 102 of FIG. 1) to supply a charge current to the battery 214 via charge IC 210 of the wireless headphone 200 to increase state of charge (SOC) of the battery 214. The battery 214 may be a lithium-ion battery, a lithium polymer battery, and the like. The charging case may be hardwired to an external power source or may utilize energy stored in a battery of the charging case to supply the charge current to the battery 214 of the wireless headphone 200. The protection IC 212 may protect the battery 214 and the wireless headphone 200 system from overvoltage, overcharge, over discharge, excess discharge, provide surge protection, and the like. Additionally, the microphone 222 may include a terminal 232 connected to ground 234.

The Bluetooth chipset 202 may comprise a charger input (VCHG) 216, an I2C communication bus 236, a first analog to digital converter (ADC1) 218, a battery voltage (VBAT) 220, a POWKEY button 228, and a second analog to digital convert (ADC2) 230. Instructions stored and executed in at least one memory of the Bluetooth chipset 202 may be used to monitor and manage the battery 214 and other hardware components of the wireless headphone. The VCHG 216 may receive electronic power via the power source described above. A charging voltage of the charging case (e.g., charger) may be input to the Bluetooth chipset 202 via VCHG 216. The I2C communication bus 236 may communicatively couple the charge IC 210 with the wireless headphone 200 system. Additionally, the I2C communication bus 236 may communicatively couple various hardware components of the wireless headphone 200.

The ADC1 218 may be communicatively coupled to the protection IC 212. As such, the Bluetooth chipset 202 may receive input from the protection IC 212 via ADC1 218. In this way, the ADC1 218 may measure battery voltage. The VBAT 220 may be communicatively coupled to the protection IC 212 such that the Bluetooth chipset 202 may receive input from the protection IC 212 via VBAT 220. The ADC2 230 may be communicatively coupled to a temperature sensor 240 such that the temperature of the battery may be measured. One example of the temperature sensor 240 may include a negative temperature coefficient (NTC) thermistor. Other embodiments of the present disclosure may utilize alternative types of temperature sensors. The POWKEY button 228 may be communicatively coupled to the tap touch IC 238 to power on and power off the Bluetooth chipset 202.

The Bluetooth antenna 204 may receive wirelessly transmitted signals from an audio source (e.g., cellular device) paired to the wireless headphones. Additionally, in some embodiments, one wireless headphone may function as the master whereas another wireless headphone may function as the slave. The Bluetooth antenna 204 may enable the wireless headphone 200 (e.g., the master) to communicate with another wireless headphone 200 (e.g., the slave) via radio frequency (RF) signals. The radio frequency (RF) filter 206 may allow or prevent pre-determined signals or frequencies to eliminate noise or pass through of undesired signals.

Sound may be received at the microphone 222 where the sound may be converted to an audio signal. The Bluetooth chipset 202 may receive input in the form of the audio signal and may process the audio signal to perform various functionalities (e.g., Bluetooth headset for phone calls). Additionally, sound may be output from the Bluetooth chipset 202 via the loudspeaker 224. The loudspeaker 224 may receive and process audio signals from the Bluetooth chipset 202 and output sound to a user of the wireless headphone. The LED 226 may alert the user via various light patterns that the wireless headphone 200 is pairing to an electronic device (e.g., cellular phone) or successfully paired to the electronic device. Additionally, the LED 226 may utilize alternative light patterns to alert the user that the wireless headphone 200 is unpairing from the electronic device and/or the charge level of the battery 214 in wireless headphone 200 is at a low state of charge (SOC).

It may be understood that the examples are provided are illustrative and do not limit the scope of the disclosure. The wireless headphone may include additional or alternative hardware components and configuration of various hardware components without departing from the scope of the disclosure.

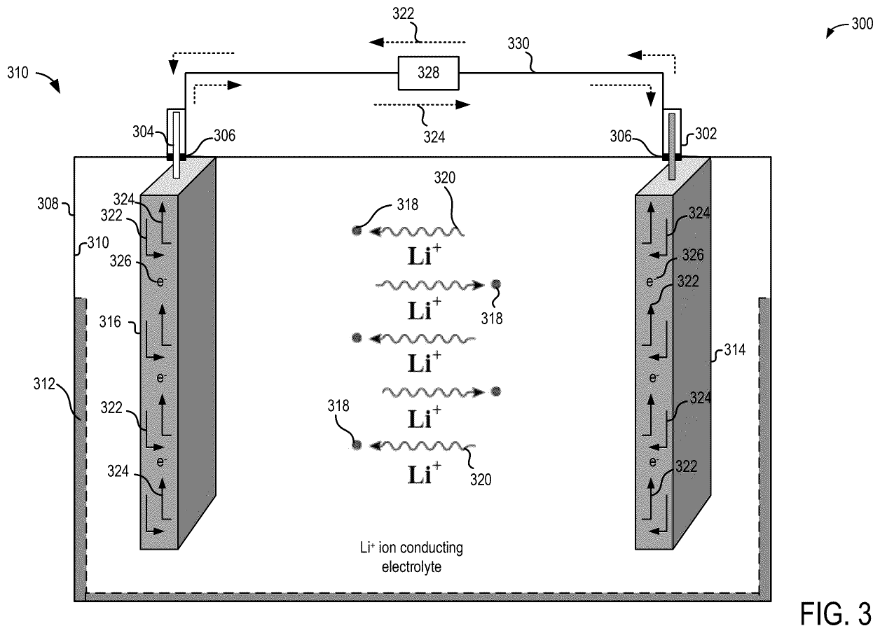

Turning to FIG. 3, an illustration of a schematic of an example battery cell of a lithium-ion battery 300, including a battery housing or case such as a neutral metal can 308 a positive electrode 302, and a negative electrode 304. The lithium-ion battery 300 may be one example of a left earbud battery, a right earbud battery, and/or a charging case battery. Insulators 306 are positioned between the neutral metal can 308 and both the positive electrode 302 and the negative electrode 304 so that there is no electrical connection therebetween. The neutral metal can 308 may comprise aluminum, stainless steel, or nickel plated steel, and alloys thereof, and may comprise an interior surface 310.

In some embodiments, the lithium-ion battery 300 may include reference electrode 312 electroplated on the interior surface of the neutral metal can 308. As shown herein, the reference electrode 312 may coat a portion of the interior surface of the neutral metal can 308, however, in some embodiments, the reference electrode 312 may uniformly coat the interior surface of the neutral metal can.

Positive electrode 302 of the lithium-ion battery 300 may be connected to a positive current collector 314. The positive current collector 314 and positive electrode 302 may comprise a metal oxide such as LiMO₂, wherein M may be Co, Ni, Mn, and the like. Other known positive electrode material may also be utilized. The positive electrode material may further include a layered crystalline structure. The negative electrode 304 may be electrically connected to a negative current collector 316. The negative current collector 316 and the negative electrode 304 material may comprise graphitic carbon having a graphitic layered structure. In other embodiments, the negative current collector 316 and the negative electrode 304 may comprise alternative or additional materials.

A lithium-ion conducting electrolyte (e.g., lithium hexafluorophosphate (LiPF₆) dissolved in a mixture of organic solvents (e.g., carbonates) may act as an ionic pathway within the lithium-ion battery 300 between the materials of the positive electrode 302 and negative electrode 304. The electrolyte may be formulated depending on the electrode materials used and battery operating conditions. The electrolyte may further comprise additives for mitigating overcharge and extending battery life. As shown in FIG. 3, the neutral metal can 308 is not electrically connected to either electrode.

During a charging mode of the battery, voltages may be applied to the lithium-ion battery 300 via a load 328 connected to both the positive electrode 302 and the negative electrode 304 via electrical connector 330. In this way, lithium ions 318 may be extracted from the interstitial space between the layers of the positive electrode material by electrochemical oxidation and may simultaneously conduct flow of current from the positive electrode 302 to the negative electrode 304, as indicated by arrows 322. The electron current (e.g., electron 326) flows from the negative electrode 304 to the positive electrode 302, as indicated by arrows 324. The lithium ions 318 are extracted and conducted through the liquid electrolyte, as indicated by arrows 320, and intercalated in the layers of the negative electrode material during electrochemical reduction of the graphitic carbon material.

When the positive electrode 302 and the negative electrode 304 of a charged battery are electrically connected via electrical connector 330 and load 328, the lithium battery ion spontaneously discharges. During discharge, graphitic carbon at the negative electrode 304 may be oxidized while lithium ions 318 are deintercalated from the negative electrode material layers, and conducted through the liquid electrolyte to the positive electrode material, where they are intercalated. Electron 326 generated at the negative electrode material flow from the negative electrode 304 to the positive electrode 302, powering load 328. During discharge, positive electrode material is reduced.

The lithium-ion battery 300 may also comprise a solid electrolyte interface (SEI) (not shown in FIG. 3) between the negative electrode material and the liquid electrolyte. The SEI may permeable to lithium ions 318 but not to the liquid electrolyte, and thereby protects the lithium ions 318 being intercalated in the negative electrode material from reacting with the liquid electrolyte. During the initial charge of the battery, a permanent passivation layer of SEI may be formed at the interface between the negative electrode 304 and the liquid electrolyte. Accordingly, the liquid electrolyte may be in fluid contact with the SEI, the positive electrode material, and the neutral metal can 308.

In some embodiments, the geometry of the lithium-ion battery cells may be cylindrical, prismatic, pseudo-prismatic, and the like. Additionally, in other embodiments, the various components of the lithium-ion battery 300 may include additional or alternative components, materials of fabrications of the components, configurations of the components, electrolytes, and the like without departing from the scope of the disclosure.

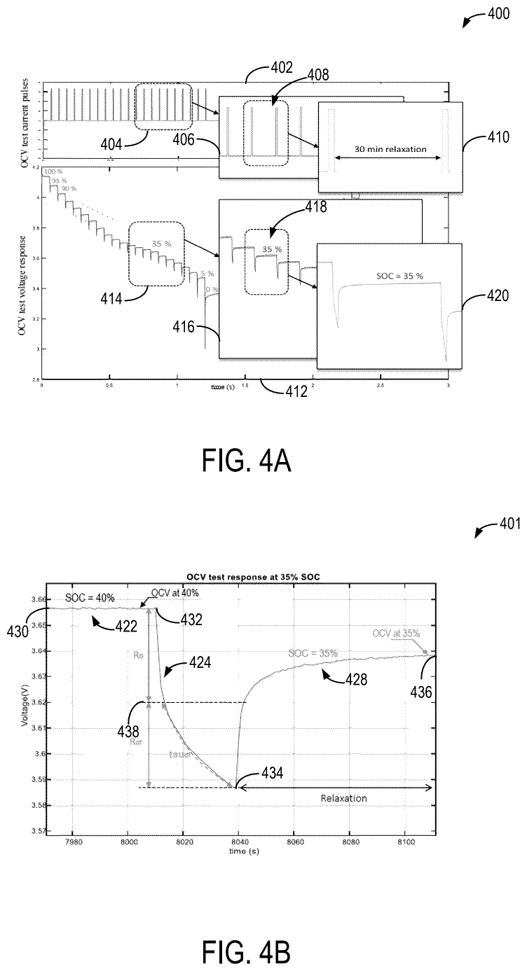

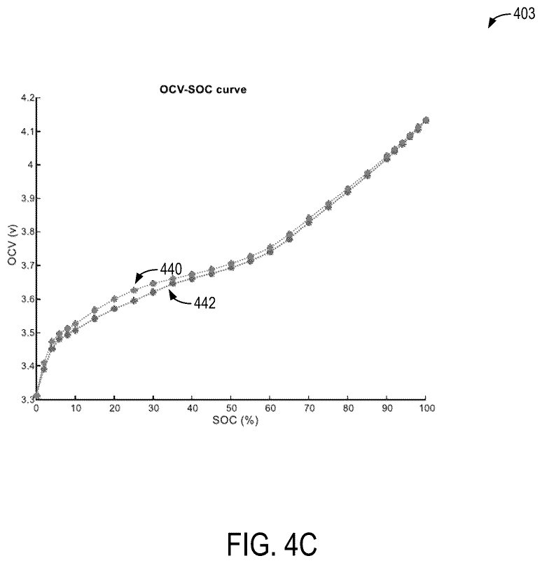

FIGS. 4A, 4B, and 4C demonstrate the various battery tests performed to construct an SOC-OCV curve. As shown in FIG. 4A, an open circuit voltage (OCV) discharge test current and voltage response 400. The open circuit voltage (OCV) discharge test current and voltage response 400 may comprise an OCV discharge test current input 402 on an earbud battery of wireless headphones and an OCV test voltage response output 412 of an earbud battery of wireless headphones at a pre-determined earbud battery temperature. Initially, the earbud battery of the wireless headphones is fully charged and has a state of charge of 100%.

The OCV discharge test current input 402 includes a plurality of discharge current pulses being supplied to the earbud battery of wireless headphones at pre-determined time intervals. The plurality of discharge current pulses may have pre-determined amplitudes and pre-determined time durations wherein the plurality of discharge current pulses is supplied to the earbud battery. For example, the amplitude of the discharge pulse may result in a 5% decrease of the OCV and SOC of the earbud battery. The OCV test voltage response output 412 describes the behavior of the earbud battery voltage in response to the plurality of discharge current pulses supplied to the earbud battery. As the plurality of discharge current pulses are supplied to the earbud battery, the OCV of the earbud battery decreases in addition to the SOC of the earbud battery. In the present example, each discharge current pulse decreases the value of the OCV and SOC to a value lower than the previous discharge current pulse. Other earbud battery experimental setups may exhibit different behavior in response to discharge current pulses being supplied to the earbud battery. However, the plurality of discharge current pulses may be supplied to the earbud battery until the earbud battery reaches a SOC of 0%. The test may be repeated at different earbud battery temperatures (e.g., −15° C. to 55° C. in 10° C. intervals).

A first rounded box 404 (e.g., dashed line) encloses a subset of the plurality of discharge current pulses. A second rounded box 414 (e.g., dashed line) encloses a subset of the OCV test voltage response output 412. The second rounded box 414 describes the behavior of the earbud battery over an interval that includes a SOC of 35%. A first box 406 includes an enlarged image of the subset of the plurality of discharge pulses whereas a second box 416 includes an enlarged image of the subset of the OCV test voltage response output 412. A third rounded box 408 (e.g., dashed line) encloses two discharge current pulses in the first box 406. Similarly, a fourth rounded box 418 (e.g., dashed line) encloses two voltage response outputs of the second box 416. A third box 410 includes an enlarged image of the two discharge current pulses in the third rounded box 408 whereas a fourth box 420 includes an enlarged image of the two voltage response outputs in the fourth rounded box 418.

The third box 410 comprises the two discharge current pulses separated by a thirty-minute relation period wherein no discharge current pulses are supplied to the battery during this time frame. The fourth box 420 comprises the two voltage response outputs wherein the voltage response outputs indicate a transient period wherein the earbud battery system is not at steady-state. The two voltage response outputs in the fourth box 420 are separated by a period wherein the earbud battery system is returning to steady-state before the subsequent discharge current pulse is supplied to the earbud battery.

Turning to FIG. 4B, an open circuit voltage (OCV) test response curve 401 illustrates an OCV test response at 35% SOC. A similar experimental procedure to FIG. 4A may yield the OCV test response curve 401. In particular, a discharge current pulse may be supplied to an earbud battery wherein the discharge current pulse results in a 5% reduction of the OCV and SOC of the earbud battery. More specifically, the OCV test response curve 401 illustrates the discharge current pulse reducing the OCV and SOC of the earbud battery from 40% to 35%.

The OCV test response curve 401 may comprise a first curve portion 422, a second curve portion 424, and a third curve portion 428. The first curve portion 422 may include a linear region bounded by a first endpoint 430 and a second endpoint 432. The first curve portion 422 may encompass the steady-state of an earbud battery system. The second curve portion 424 may include a curved region bounded by the second endpoint 432 and a third endpoint 434. The values along the curved region of the second curve portion 424 may decrease in value from the second endpoint 432 and the third endpoint 434. The third curve portion 426 may include a curved region bounded by the third endpoint 434 and a fourth endpoint 436. The values along the curved region of the third curve portion 426 may increase in value from the third endpoint 434 to the fourth endpoint 436.

The second curve portion 424 may be bisected by a line 438 (e.g., dashed line). The upper region of the second curve portion 424 and lower region of the second curve portion 424 bisected by the line 438 may be used to determine various performance parameters of the earbud battery. In particular, the upper region of the second curve portion 424 may be used to determine the internal resistance R₀ of the earbud battery and the lower region of the second curve portion 424 may be used to determine the resistance R_{df}. The resistance R_{df} may encompass other sources of resistance in the earbud battery. A time constant τ_{df} may describe the delayed response of the earbud battery, in response to the discharge current pulse, before the earbud battery system begins to equilibrate and heads towards a new steady-state of the earbud battery system. The fourth endpoint 436 may correlate to the point at which the earbud battery system achieves the new steady-state. The OCV value and SOC value of the earbud battery may be determined based on the values at the fourth endpoint 436.

FIG. 4C illustrates a state of charge (SOC)-open circuit voltage (OCV) curve 403. The SOC-OCV curve 403 that be utilized to determine the SOC of an earbud battery at various OCVs during the non-charging mode of the earbud and the charging mode of the earbud. The SOC-OCV curve 403 may comprise an OCV charge curve 440 and OCV discharge curve 442. The OCV discharge curve 442 may be constructed according to the procedure and corresponding values determined from the procedures discussed above with respect to FIGS. 4A and 4B. However, the OCV charge curve 440 may be constructed via a modified version of the procedure referred to in FIGS. 4A and 4B. In particular, the earbud battery may initially start at 0% SOC and a charge current pulse is supplied to the earbud battery instead of a discharge current pulse to increase the SOC of the earbud battery by a pre-determined percentage. In this way, OCV values and their corresponding SOC values may be determined for the charging mode.

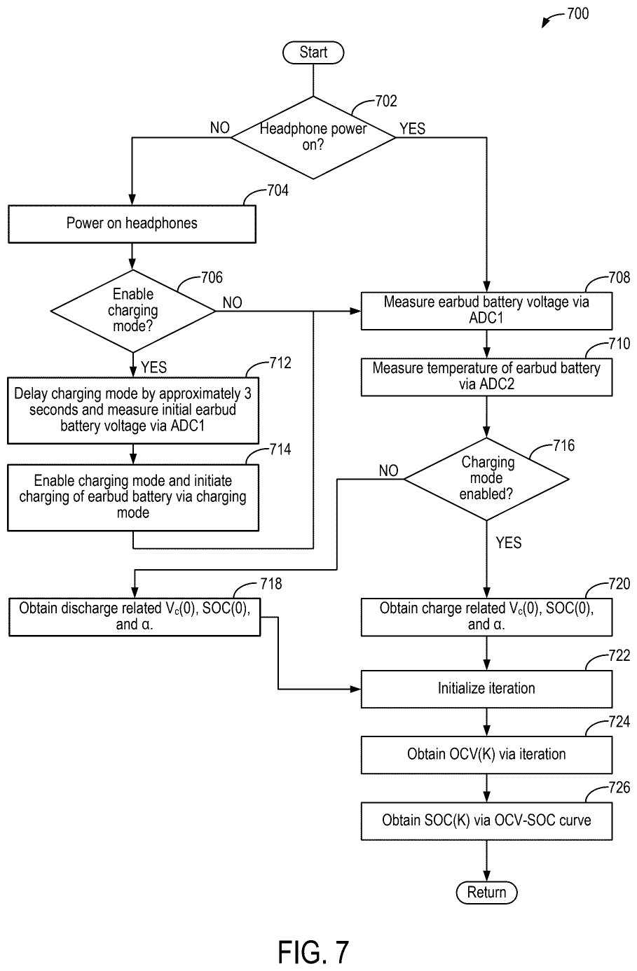

Regardless of whether the earbud battery is operating in a charging mode or a non-charging mode, the SOC of the earbud battery may be determined if the OCV value of the earbud battery is known. SOC values may be determined via linear interpolation between two data points for intermediate OCV values (e.g., OCV values that were not used to construct the curve). Additionally, the OCV charge curve 440 and OCV discharge curve 442 may be constructed based on OCV tests performed at different temperatures. In this way, temperature effects on OCV and SOC values may be incorporated into the methods (e.g., method 700 of FIG. 7) described herein.

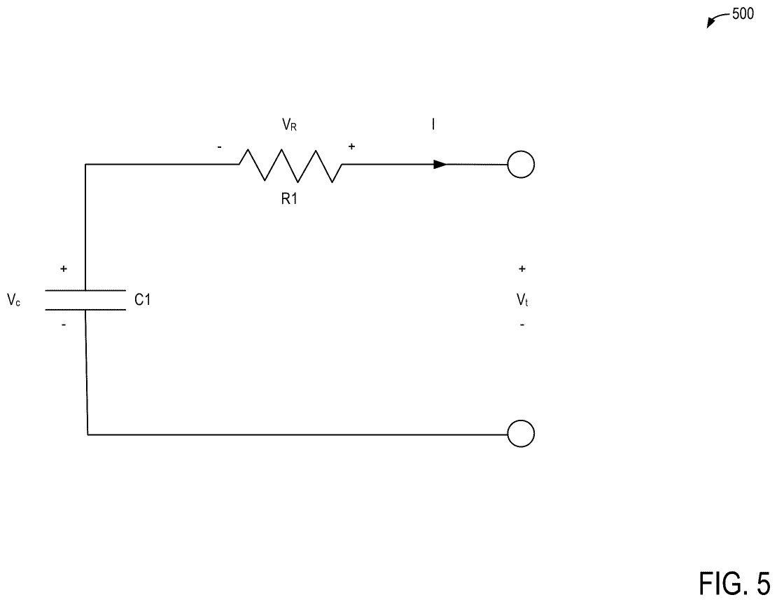

As illustrated in FIG. 5, a battery model 500 of wireless headphone batteries. The battery model 500 of the earbud battery may be modeled by a first order resistor-capacitor (RC) circuit. The first order RC circuit may be follow the equation below:

$${V}_{c} [ K ] = ( 1 - α ) \cdot {V}_{c} [ K - 1 ] + {V}_{t} [ K ] \cdot α \qquad ( 1 )$$

wherein V_{c}[K] is the open circuit voltage (OCV) at time K, V_{c}[K−1] is the open circuit voltage (OCV) at time K−1, Vₜ[K] is the ADC reading voltage at time K, and α is a coefficient.

The coefficient α may be determined according to the following equation:

$$α = \frac{{T}_{s}}{{T}_{s} + {RC}^{′}} \qquad ( 2 )$$

wherein Tₛ is a pre-determined sampling time that may be adjusted by an ADC and RC′ is a time constant that may be determined by various battery test methods, including an open circuit voltage test, a charge/discharge test, and the like. As such, the coefficient α is a function of various parameters, including the time constant, RC′, the sampling time, Tₛ, state of charge (SOC) of the earbud battery, and temperature of the earbud battery. The various parameters may be referred to herein as charging parameters during a charging mode of the wireless earbud battery and discharging parameters during a non-charging mode of the wireless earbud battery. The battery test methods utilized to determine RC′ may be performed at different temperatures and different state of charge (SOC) of the earbud battery. For example, the battery test methods may be performed from −15° C. to 55° C. in 10° increments. In another example, the battery test methods may be performed at various state of charge (SOC) that may range from 0% to 100%.

Vₜ[K] may be read at time K by a first-analog to digital converter (ADC1). V_{c}[K−1] may be determined iteratively by approximating an initial open circuit voltage (OCV) for the wireless earbud. For example, in the case wherein the wireless earbud is initially powered on, the current, I, is very small. As such, the initial open circuit voltage may be approximately equal to the ADC reading voltage at time K=0 (e.g., V_{c}[0]=Vₜ[0]). An initial coefficient α may be calculated by determining an initial state of charge (SOC) of the earbud battery, an initial temperature of the earbud battery, an initial sampling time Tₛ, and an initial time constant RC′. The initial state of charge (SOC) of the earbud battery and initial temperature of the earbud battery may be estimated based on an updated SOC of the earbud battery determined during the charging mode or non-charging mode.

Once the headphone starts charging or discharging, the open circuit voltage (OCV) may be described according to the following equation at K=1.

$${V}_{c} [ 1 ] = ( 1 - α ) \cdot {V}_{c} [ 0 ] + {V}_{t} [ 1 ] \cdot α \qquad ( 3 )$$

In this way, V_{c}[K−1] may be determined for other times, K. However, for each iteration, the charging parameters and discharging parameters may be determined to determine OCV at time K. In particular, a subsequent temperature of the earbud battery and subsequent state of charge (SOC) of the earbud battery at time K may be determined based on the previous SOC of the earbud battery and previous temperature of the earbud battery. In this way, the time constant RC′ may be determined based on the SOC of the earbud battery and temperature of the earbud battery from a database including pre-determined experimentally determined time constant RC′. The charging parameter, coefficient α at time K, may be calculated by determining charging parameters or discharging parameters at time K wherein the charging parameters and discharging parameters include the sampling time Tₛ and a time constant RC′ at time K.

As such, the open circuit voltage at time K may be determined by calculating a subsequent open circuit voltage (OCV) of the earbud battery at a subsequent time via the model equation, the charging parameters at the subsequent time, and a previous open circuit voltage. For example, at K=2, V_{c}[K−1]=V_{c}[1] which was determined in the previous iteration step wherein K=1. As such, V_{c}[K−1] is determined iteratively wherein each iteration determines the value of V_{c}[K−1] for the next iterative step. For each iteration, the open circuit voltage at time K, V_{c}[K], may be determined. Accordingly, the state of charge (SOC) at time K, SOC[K], may be determined from V_{c}[K] based on the SOC-OCV curves described herein.

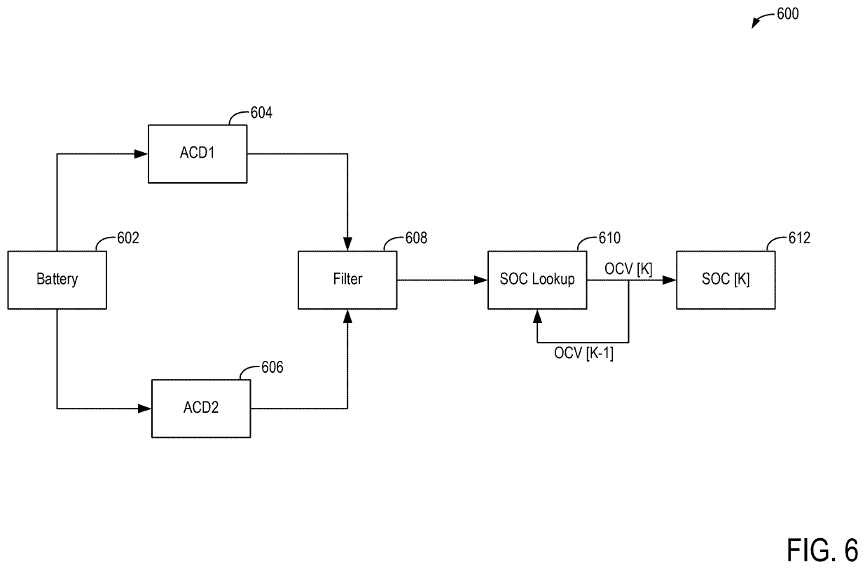

FIG. 6 illustrates a block diagram of a control scheme 600 for determining state of charge (SOC) of an earbud battery. The control scheme 600 may be implemented by a left earbud of the wireless headphones independent from the right earbud of the wireless headphones. In this way, the SOC of a battery of the left earbud may be determined and the SOC of a battery of the right earbud may be determined independently. Additionally, in some embodiments of the present disclosure, the control scheme 600 may be implemented by a charging case of the wireless headphones to determine the SOC of the left earbud and the SOC of the right earbud.

At 602, the earbud battery outputs values of various monitoring parameters to determine state of charge (SOC) of the earbud battery. Earbud battery temperature may affect battery performance with regards to discharging the earbud battery during a non-charging mode and charging the earbud battery during a charging mode. As such, the earbud battery may output a temperature reading determined via a temperature sensor. Additionally, battery voltage is related to the state of charge (SOC) of the earbud battery. Therefore, the earbud battery may output a battery voltage reading.

At 604, a first analog to digital converter (ADC1) receives input from the earbud battery. In one embodiment, the first analog to digital converter (ADC1) may receive an analog signal corresponding to an earbud battery voltage and convert the analog signal to a digital signal that may be stored and accessed in at least one memory of a microcontroller unit (MCU). Executable instructions may be executed in at least one memory of the microcontroller unit (MCU) to access the earbud battery voltage. In this way, the state of charge (SOC) of the earbud battery may be determined at various points in time by storing and accessing a plurality of earbud battery voltages at various points in time. Other embodiments of the present disclosure may receive alternative monitoring parameter inputs at the first analog to digital converter (ADC1), such as temperature

At 606, a second analog to digital converter (ADC2) receives input from the earbud battery. In some embodiments of the present disclosure, the second analog to digital converter (ADC2) may receive an analog signal corresponding to an earbud battery temperature and convert the analog signal to a digital signal that may be stored and accessed in at least one memory of a microcontroller unit (MCU). Executable instructions may be executed in at least one memory of the microcontroller unit (MCU) to access the earbud battery temperature. In this way, the state of charge (SOC) of the earbud battery may be determined at various points in time by storing and accessing a plurality of earbud battery temperatures at various points in time. Other embodiments of the present disclosure may receive alternative monitoring parameter inputs at the second analog to digital converter (ADC2), such as earbud battery voltage.

At 608, a filter receives input from the first analog to digital converter (ADC1) and the second analog to digital converter (ADC2). The filter may be executable instructions configured, stored, and executed in at least one memory of the microcontroller unit (MCU). The filter may receive earbud battery voltage from the first analog to digital converter (ADC1) and earbud battery temperature input from the second analog to digital converter (ADC2) via the executable instructions. In this way, various parameters of a model equation (e.g. the first order RC circuit of FIG. 5) of the earbud battery may be determined based on earbud battery voltage and earbud battery temperature at various points in time during the charging mode or non-charging mode of the earbud battery.

At 610, a state of charge (SOC) lookup may receive input from the filter. In particular, the SOC lookup may receive the various charging or discharging parameters of the model equation of the earbud battery temperature at various points in time during the charging mode or non-charging mode of the earbud battery determined by the filter. The subsequent open circuit voltage (OCV) of the earbud battery may be determined via the model equation and the corresponding charging or discharging parameters or previous charging or discharging parameters of the model equation. The state of charge (SOC) may be determined via the OCV and pre-determined experimental data from pre-constructed state of charge-open circuit voltage (SOC-OCV) curves. Additionally, after determining the open circuit voltage OCV [K] at a time t=K, the value of the OCV [K] may be stored in at least one memory of the microcontroller unit (MCU) as OCV [K−1] to determine the subsequent OCV and SOC of the earbud battery.

At 612, the state of charge (SOC) of the earbud battery at a particular point in time may be output from the SOC lookup. In some embodiments, the SOC of the earbud battery at a particular point in time may be output to a display device of an electronic device, such as the screen of a cellular phone, as one example. In this way, the user of the earbud may interact with the display device to display the current state of charge of the earbud battery. In some embodiments of the present disclosure, the SOC may be converted to an equivalent fuel gauge level. The fuel gauge level may be based on the SOC via a look-up table that maps SOC for a given temperature to a displayed “fuel” level on a display of a device communicating with the case and/or one or more of the left and right earbuds.

FIG. 7 illustrates a method 700 for determining state of charge (SOC) of batteries in wireless headphones via instructions. The method 700 may be implemented by a left earbud of the wireless headphones independent from the right earbud of the wireless headphones. The method 700 may be implemented by a right earbud of the wireless headphones independent from the left earbud of the wireless headphones. In this way, the SOC of a battery of the left earbud may be determined and the SOC of a battery of the right earbud may be determined independently. Further, the method 700 may be executed by the left earbud independently from the right earbud at the same time or at different times. Additionally, in some embodiments of the present disclosure, the method 700 may be implemented by a charging case of the wireless headphones to determine the SOC of the left earbud and the right earbud during a charging mode and a non-charging mode of the wireless headphones. The charging mode may comprise supplying a charge current to a left earbud battery or to a right earbud battery. The non-charging mode may comprise one or more of a supplying a discharge current to the left earbud battery or to the right earbud battery, entering and maintaining a passive state, and a leakage current wherein a flow of current occurs during the passive state.

At 702, the method 700 includes determining whether an earbud is powered on. A power condition may be utilized to determine whether the earbud is powered on. In one example, a plurality of sensors in the wireless headphones may determine whether the wireless headphones are powered on when a discharge current is applied. In particular, a first sensor of the plurality of sensors in the wireless headphones may detect whether the left earbud is mated to the charging contacts/contact pins of a left cavity and a second sensor may detect whether the right earbud is mated to the charging contacts/contact pins of a right cavity. Additionally, at least one of the first sensor and the second sensor in the plurality of sensors may detect whether the wireless headphones are inserted in the ear of a user. In some embodiments of the present disclosure, at least one of the first sensor or second sensor may be a pressure sensor that may detect changes in pressure or a temperature sensor temperature that detect changes in temperature that may indicate whether the wireless headphones are inserted in the ear of the user.

In another example, the earbud may be powered on when the plurality of sensors in the wireless headphones or a plurality of sensors in the charging case determine that a charge current or voltage is being supplied to the wireless headphones and the battery is not at full charge capacity. In this way, while power is supplied to the wireless headphones via the charging case, the wireless headphones may be powered on. In contrast, when power is not supplied to the wireless headphones via the charging case, the wireless headphones may be powered off. Other embodiments of the present disclosure may utilize alternative power conditions to determine whether the earbud is powered on. If it is determined that the wireless headphones are powered on, the method 700 proceeds to 708 and includes measuring a battery voltage via a first analog to digital converter (ADC1).

At 704, the method 700 includes powering on earbuds responsive to determining the earbuds are not powered on. The wireless headphones may be powered on by the user when a discharge current is applied to the wireless headphones. For example, to power on the headphones, the user may remove the right earbud from the charging case and insert the right earbud in the ear of the user to power on the right earbud. Similarly, the user may remove the left earbud from the charging case and insert the left earbud in the ear of the user to power on the left earbud. As described above, when a charge current is applied to the wireless headphones via the charging case and the earbud battery is not fully charged, the wireless headphones may automatically be powered on.

At 706, the method 700 includes determining if enabling a charging mode of the battery is requested. The charging mode of the battery may be enabled by receiving an initialization condition. For example, in some embodiments of the present disclosure, the initialization condition may include charging contacts of wireless headphones mating with the charging contacts/pins of the charging case, such as the charging case 102 illustrated in FIG. 1, as electronic power is supplied to the wireless headphones via the charging case. In contrast, the charging mode of the battery may not be requested in the case where the charging contacts of wireless headphones are not properly mated or not mated altogether with the charging contacts/pins of the wireless headphones. In this way, a charge current may not flow from the charging case to the wireless headphones. Similarly, the charging mode of the battery may not be requested in the case where the charging case is not connected to an external power source or the charging case is not charged (e.g., wireless charger). If it is determined that enabling of the charging mode is not requested, the method 700 proceeds to 708 and includes measuring the battery voltage via the first analog to digital converter (ADC1).

At 712, the method 700 includes delaying the charging mode by approximately three seconds and measuring an initial battery voltage via the ADC1 responsive to enabling the charging mode. As described above with respect to FIG. 5, the initial open circuit voltage at time K=0, OCV(K), may be approximated by the analog to digital converter (ADC) battery reading of ADC1. Delaying the charge current to each of the left earbud battery and right earbud battery for the pre-determined time duration (e.g., three second) may comprise not supplying the charge current to the left earbud and the right earbud via one of the plurality of integrated circuits via the charging case, determining initial charging parameters for the left earbud battery at time t=0 based on pre-determined experimental data, a temperature sensor of the left earbud battery, and voltage of the left earbud battery, and determining initial charging parameters for the right earbud battery at time t=0 based on pre-determined experimental data, a temperature sensor of the right earbud battery, and voltage of the right earbud battery.

By delaying the charge current that is applied to the earbud battery of the wireless headphones, the accuracy of the ADC battery reading may be increased. Since the charge current is delayed, the voltage of the ADC battery reading may not be affected by the charge current or voltage applied to the earbud battery, which may prevent voltage readings that are higher or lower than the true voltage reading. In this way, the ADC battery reading may be closer to the true voltage reading. Overall, the delay may increase the accuracy of determining the SOC of the battery since the iterative process of the method 700 relies on an initial voltage reading of the ADC battery reading via ADC1. By increasing the accuracy of the initial voltage reading, the accuracy of voltage readings in subsequent steps of the method 700 may also be increased.

At 714, the method 700 includes enabling the charging mode and initiating charging of a battery via the charging mode. In some embodiments of the present disclosure, an initialization condition may enable the charging mode of the earbud battery. As one example of the initialization condition, inserting the earbud into the charging case and mating the earbud charge contacts of the wireless headphones and the charge contacts/pins of the charging case for the duration of the three second delay may enable and initialize the charging mode. Accordingly, after the delay, the charge current or voltage may be applied to the earbud battery. As another example of the initialization condition, the charging mode of the wireless headphones may be enabled and initiated by supplying a charge current or voltage to the earbud battery. In this way, electronic power is supplied to the earbud battery, which may adjust the open circuit voltage (e.g., increase the voltage) and the temperature of the battery, which effectively may increase the state of charge (SOC) of the earbud battery over time as the charge current or voltage is applied and the earbud battery is not fully charged. Other embodiments may utilize alternative or additional initialization conditions than described herein.

At 708, the method 700 includes measuring a battery voltage via the ADC1. The earbud battery may be communicatively coupled to a first analog-to-digital converter (ADC1) of the Bluetooth chipset or MCU. In this way, the ADC1 output (e.g., battery voltage) may be stored in at least one memory of the Bluetooth chipset or MCU. As such, the executable instructions may access the battery voltage values measured at various times that are stored in at least one memory of the Bluetooth chipset or MCU during the charging mode or non-charging mode. By accessing the voltage values of the earbud battery, the open circuit voltage (OCV) and state of charge (SOC) of the earbud battery may be determined according to the methods described herein.

At 710, the method 700 includes measuring a temperature of the earbud battery via the ADC2. A temperature sensor of a plurality of sensors communicatively coupled to the earbud battery may measure the earbud battery temperature. The temperature sensor may be communicatively coupled to a second analog-to-digital converter (ADC2) of the Bluetooth chipset or MCU. In this way, the ADC2 output (e.g., earbud battery temperature) may be stored in at least one memory of the Bluetooth chipset or MCU. As such, the executable instructions may access the earbud battery temperatures values measured at various times that are stored in at least one memory of the Bluetooth chipset or MCU during the charging mode or non-charging mode. By accessing the temperature of the earbud battery, the open circuit voltage (OCV) and state of charge (SOC) may be determined at various temperatures according to the methods described herein.

At 716, the method 700 includes determining whether the charging mode is enabled. As described above with respect to the method 700, the charging mode may be enabled by charging contacts of wireless headphones mating with the charging contacts/pins of the charging case as electronic power is supplied to the wireless headphones via the charging case. By supplying a charge current to the earbud battery via the charging case, a battery voltage is measured via ADC1, indicating that electrical power is flowing from the power source to the earbud battery. Additionally, the charging mode may be enabled by charging contacts of wireless headphones improperly mating with the charging contacts/pins of the charging case as electronic power is supplied to the wireless headphones.

Supplying the charge current to the earbud battery while the charging contacts/pin are improperly mated may result in a battery voltage being measured via ADC1, indicating that electrical power is flowing from the power source to the earbud battery. In this example the charge current strength may differ from the example described above. In contrast, the non-charging mode may be enabled by charging contacts of wireless headphones not mating with the charging contacts/pins of the charging case as electronic power is supplied to the wireless headphones via the charging case and/or power not being supplied to the wireless headphones via the charging case (e.g., the earbuds are inserted into the ear of the user).

At 718, the method 700 includes obtaining discharge related V_{C}(0), SOC(0), and initial coefficient α responsive to determining the charging mode is not enabled. The charging mode related V_{C}(0), SOC(0), and a may be considered initial discharging parameters of a model of an earbud battery. As described above with respect to FIG. 5, the initial open circuit voltage at time K=0, V_{C}(0), may be approximated by the ADC battery reading, Vₜ (0), at time K=0 of ADC1 due to a low initial discharge current. In some embodiments of the present disclosure, SOC(0) may be determined by executable instructions (e.g., an updated SOC from the charging mode) utilized via a processor in at least one memory of a microcontroller unit (MCU) of the charging case or a Bluetooth chipset of the earbud to determine SOC of the earbud batteries during the charging mode. The updated SOC of the earbud determined by the executable instructions prior to removing the earbud from the charging case may be considered SOC(0) of the non-charging mode.

As described herein with respect to FIG. 5, the coefficient α may be determined based on the sampling time, Tₛ, of the analog to digital converter and the time constant RC′. The time constant RC′ may be determined via various battery test methods that consider different factors, such as various temperature and state of charge (SOC) of the earbud battery. In some embodiments of the present disclosure, a database of time constant values RC′ at various states of charge and different temperatures may be stored in at least one memory of the Bluetooth chipset or MCU. The time constant values may be accessed to determine the initial time constant value at time K=0 of the non-charging mode at the initial state of charge, SOC(0), of the earbud battery and the initial temperature of the earbud battery. After obtaining the initial time constant RC′ value and initial sampling time Tₛ, an initial coefficient α may be calculated. The method 700 proceeds to 722 and includes initiating iteration. It may be understood that the examples provided are illustrative rather than absolute. Other embodiments of the present disclosure may utilize alternative methods for determining and obtaining discharge related V_{C}(0), SOC(0), and α.

At 720, the method 700 includes obtaining charging related V_{C}(0), SOC(0), and initial coefficient α responsive to determining the charging mode is enabled. The discharging mode related V_{C}(0), SOC(0), and initial coefficient α may be considered initial charging parameters of a model of an earbud battery. As described above with respect to FIG. 5, the initial open circuit voltage at time K=0, V_{C}(0), may be approximated by the ADC battery reading, Vₜ(0), at time K=0 of ADC1 due to a low initial charge current. In some embodiments of the present disclosure, SOC(0) may be determined by executable instructions (e.g., an updated SOC from the non-charging mode) utilized via the Bluetooth chipset of the earbud to determine SOC of the earbud batteries during the non-charging mode. The updated SOC of the earbud determined by the executable instructions prior to inserting the earbud into the charging case may be considered SOC(0) of the charging mode.

As described herein with respect to FIG. 5, the coefficient α may be determined based on the sampling time, Tₛ, of the analog to digital converter and the time constant, RC′. As described above, the time constant RC′ may be determined via various battery test methods that consider different factors, such as various temperature and state of charge (SOC) of the earbud battery. The database of time constant RC′ values at various states of charge and different temperatures may be stored in at least one memory of the Bluetooth chipset or MCU. The time constant RC′ values may be accessed to determine the initial time constant value at time K=0 of the charging mode at the initial state of charge, SOC(0), of the earbud battery and the initial temperature of the earbud battery. After obtaining the initial time constant and initial sampling time, the initial coefficient α may be calculated.

It may be understood that the examples provided are illustrative rather than absolute. Other embodiments of the present disclosure may utilize alternative methods for determining and obtaining charging related V_{C}(0), SOC(0), and α. The method 700 proceeds to 722 and includes initiating iteration.

At 722, the method 700 includes initializing iteration. Iteration of instructions stored and executed in at least one memory of the Bluetooth chipset may be initialized by an initialization condition. For example, in some embodiments, the initialization condition may include charge or discharge related V_{C}(0), SOC(0), and initial coefficient α being stored in volatile memory of the Bluetooth chipset or MCU. As another example, the initialization condition may include the charge current or discharge current supplied to the earbud battery being within a pre-determined, non-zero charge current threshold (e.g., 0.5 A). In other examples, the initialization condition may include storing the charging or discharging parameters discussed above and the charge current or discharge current being within a threshold. Other embodiments of the present disclosure may utilize additional or alternative initialization conditions to initialize iteration of the instructions.

At 724, the method 700 includes obtaining the open circuit voltage at time K, OCV(K), via iteration. The open circuit voltage at time K, OCV(K) may be determined according to a model equation (e.g., the first order RC circuit described in FIG. 5) of the earbud battery. However, prior to determining OCV(K), the value of the coefficient α may be determined with charging parameters and discharging parameters of the model of the earbud battery at a time K. As described above, the value of the coefficient α depends on the time constant RC′, the sample time Tₛ, the temperature of the earbud battery, and the SOC of the earbud battery at time K. The coefficient α, time constant RC′, the sample time Tₛ, the temperature of the earbud battery, and the SOC of the earbud battery may be considered charging parameters during the charging mode and discharging parameters during the non-charging mode.

However, the SOC of the earbud battery is unknown when the charge current or discharge current is supplied to the earbud battery. In one embodiment of the present disclosure, the instructions may include an estimation of SOC of the earbud battery and temperature of the earbud battery based on the previous SOC and temperature of the earbud battery determined by the charging case or earbud. The estimated SOC and temperature of the earbud battery may be utilized to determine the time constant RC′ at time K via the database of time constants. Once the RC′ is selected, the coefficient α may be calculated since there are no unknown independent variables. The open circuit voltage (OCV) of the earbud battery may be determined based on one of the initial discharging parameters and the discharging parameters at time K during the non-charging mode or the initial charging parameters and the charging parameters at time K during the charging mode via the model equation of the earbud battery referenced in FIG. 5.

At 726, the method 700 proceeds includes obtaining the state of charge at time K, SOC(K), via an OCV-SOC curve. The SOC of the earbud battery may be determined by linearly interpolating pre-determined experimental data from pre-constructed SOC-OCV curves (e.g., as described in FIGS. 4A-4C) stored in at least one memory of at least one of the MCU of the charging case and Bluetooth chipset of the earbud at the calculated OCV(K). In some embodiments of the present disclosure, the SOC of the earbud battery may be converted to an equivalent fuel gauge level. The method 700 then returns.

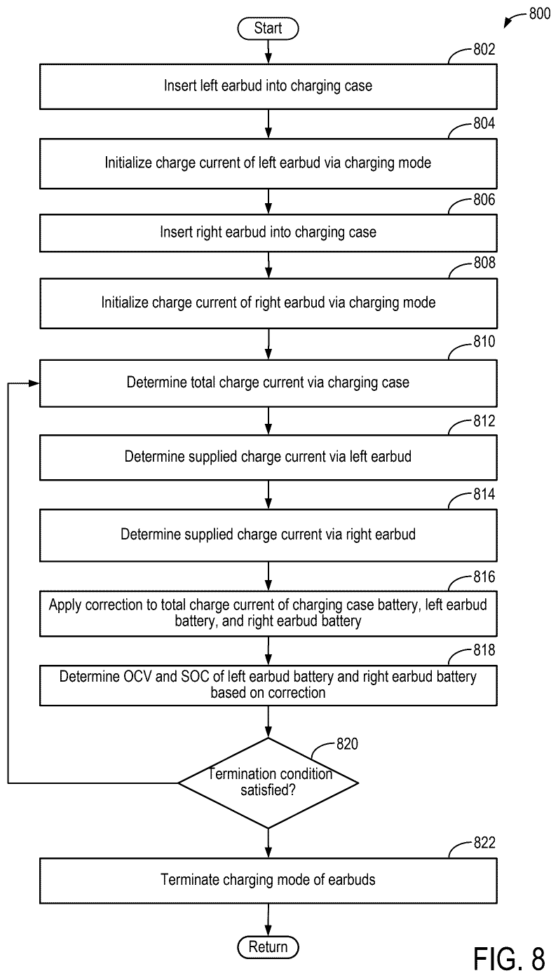

As shown in FIG. 8, a method 800 wherein a charging scheme may be implemented to charge an earbud battery of an earbud during a charging mode. The charging mode may comprise supplying a charge current to a left earbud battery and to a right earbud battery via a charging case during a charging mode. The charge current is supplied to the left earbud battery independently from the right earbud battery. Similarly, the charge current is supplied to the right earbud battery independently from the left earbud battery. In this way, a charge current may be supplied to the left earbud battery independent from the right earbud battery at the same time or at different times. The method 800 utilizes the control scheme 600 of FIG. 6 and the method 700 of FIG. 7 via a charging case of the wireless headphones, a left earbud of the wireless headphones, and a right earbud of the wireless headphones.

At 802, the method 800 includes inserting the left earbud into the charging case of the wireless headphones. Prior to enabling the charging mode of the of the wireless headphones, the charge current may be delayed to measure an initial left earbud battery voltage. In some embodiments, the delay may have a time duration of 3 seconds. Other embodiments of the present disclosure may utilize longer or shorter time durations for the delay. After the earbud battery voltage is determined via a first analog to digital converter (ADC1) of the left earbud, the charge current may be applied to the left earbud battery via the charging case battery to supply electronic power to the left earbud and charge the left earbud battery. In various embodiments of the present disclosure, the left earbud may be inserted into the charging case before, after, or at the same time as the right earbud. In the present example, the left earbud is inserted into the charging case prior to the right earbud.

At 804, the method 800 includes initiating the charge current of the left earbud via the charging mode. An initialization condition may be satisfied to initiate the charge current of the left earbud during the charging mode. In some embodiments, the initialization condition may include a timer reaching a pre-determined time duration after the left earbud is inserted into the charging case. The 3 second delay described above may satisfy this initialization condition. Other embodiments of the present disclosure may utilize an alternative initialization condition than described herein. For example, the initialization condition in other embodiments may include a sequence of events occurring after the left earbud is inserted into the charging case. After the initialization condition is satisfied, the charge current may be supplied to the left earbud, initializing the charge current to begin charging the left earbud battery. The charge current is supplied to the left earbud battery a certain time period prior to the right earbud in the present example. Accordingly, the state of charge (SOC) of the left earbud may be higher than that of the right earbud since the charge current during the charging mode is supplied earlier.

At 806, the method 800 includes inserting the right earbud into the charging case of the wireless headphones. After inserting the right earbud, the charge current may be delayed to measure an initial earbud battery voltage of the right earbud. In some embodiments, the delay may have a time duration of 3 seconds. Other embodiments of the present disclosure may utilize longer or shorter time durations for the delay. After the right earbud battery voltage is determined via a first analog to digital converter (ADC1) of the right earbud, the charge current may be applied to the right earbud battery via the charging case to supply electronic power to the right earbud and charge the right earbud battery. In various embodiment of the present disclosure, the right earbud may be inserted into the charging case before, after, or at the same time as the left earbud. In the present example, the right earbud is inserted into the charging case after the left earbud.

At 808, the method 800 includes initiating the charge current of the right earbud via the charging mode. As described above with respect to the left earbud, the initialization condition may be satisfied to initiate the charge current of the right earbud during the charging mode. The initialization condition for the left earbud and the right earbud may be the same in some embodiments. In other embodiments, the initialization condition may be different for the left earbud and the right earbud. After the initialization condition is satisfied, the charge current may be supplied to the right earbud, initializing the charge current to begin charging the right earbud battery. As such, the charge current is supplied to the left earbud battery for a certain time period prior to the right earbud in the present example. Accordingly, the state of charge (SOC) of the right earbud may be lower than that of the left earbud since the charge current during the charging mode is supplied later.

At 810, the method 800 includes determining total charge current via the charging case. Instructions configured, stored, and executed in at least one memory of a microcontroller unit (MCU) of the charging case may determine the total charge current via a charging case battery. In particular, the total charge current may be determined for the charging case battery based on a model of the charging case battery. The at least one communication bus of the charging case may be communicatively coupled to the left earbud and the right earbud. In this way, the total charge current supplied by the charging case battery may be compared with the total charge current supplied to the left earbud battery and the right earbud battery, respectively.

At 812, the method 800 includes determining the supplied charge current via the left earbud. Instructions configured, stored, and executed in at least one memory of a Bluetooth chipset of the left earbud may determine the supplied charge current to the left earbud battery. In particular, the supplied charge current may be determined for the left earbud battery based on a model of the left earbud battery. The at least one communication bus of the charging case may be communicatively coupled to the left earbud. In this way, the supplied charge current to the left earbud battery and the right earbud battery may be compared with the total charge current supplied by the charging case battery.

At 814, the method 800 includes determining the supplied charge current via the right earbud. Instructions configured, stored, and executed in at least one memory of a Bluetooth chipset of the right earbud may determine the supplied charge current to the right earbud battery. In particular, the supplied charge current may be determined for the right earbud battery based on a model of the right earbud battery. The at least one communication bus of the charging case may be communicatively coupled to the right earbud. In this way, the supplied charge current to the right earbud battery and left earbud battery may be compared with the total charge current supplied by the charging case battery.

At 816, the method 800 includes applying a correction to the total charge current of the charging case battery, left earbud battery, and right earbud battery. Significant differences between the total charge current supplied to the left battery and right earbud battery via the charging case and the sum of the left earbud battery current and right earbud battery charge current may decrease the accuracy of the charging case, the left earbud, and the right earbud to determine state of charge (SOC) of the left earbud battery and right earbud battery.

A correction to state of charge (SOC) of one or more of the charging case battery, left earbud battery, and right earbud battery based on a difference between the estimate of total charge current and the sum of the left earbud battery charge current and right earbud battery charge current in response to charging the left earbud battery and right earbud battery via the charging case may increase the accuracy of the charging case, the left earbud, and the right earbud to determine state of charge (SOC) of the left earbud battery and the right earbud battery. The state of charge (SOC) of the left earbud battery may be corrected indirectly by applying the correction to the total charge current. The correction may be considered a current correction factor wherein at least one or more of the total charge current supplied by the charging case battery, the charge current supplied to left earbud, and the charge current supplied right earbud is adjusted by the current correction factor.

In one embodiment, the current correction factor may be the magnitude of the difference between the estimate of the total charge current supplied by the charging case battery and the sum of the left earbud battery charge current and the right earbud battery charge current. In some embodiments, the current correction factor may be a percentage of the magnitude of the difference between the estimate of the total charge current supplied by the charging case battery and the sum of the left earbud battery charge current and the right earbud battery charge current. Other embodiments of the present disclosure may utilize alternative or additional corrections and/or current correction factors, such as an absolute difference.

At 818, the method 800 includes determining OCV or SOC of the left earbud battery and the right earbud battery based on the correction. To determine the open circuit voltage (OCV) of the left earbud battery and the right earbud battery with greater accuracy, the variables utilized (e.g., the variables referred to in FIG. 5) to determine OCV of the left earbud battery and OCV of the right earbud battery may incorporate the correction or current correction factor described above. In particular, utilizing the current correction factor of the left earbud to determine a corrected voltage of the left earbud battery and the current correction factor of the right earbud to determine a corrected voltage of the right earbud battery may increase the accuracy of the system and methods described herein to monitor the state of charge (SOC) of wireless headphones.

The corrected voltages may be applied to the charging case battery, the left earbud battery, and right earbud battery via the various hardware components of the wireless headphone system. More specifically, the corrected voltage of the left earbud battery may be transmitted to the Bluetooth chipset of the left earbud via the communication bus of the charging case. Similarly, the corrected voltage of the right earbud battery may be transmitted to the Bluetooth chipset of the right earbud via the at least one communication bus of the charging case. The corrected voltages may be accessed by the instructions stored and executed in the microcontroller unit (MCU) of the charging case, the left Bluetooth chipset of the left earbud, and the right Bluetooth chipset of the right earbud.

As such, the methods described herein (e.g., FIGS. 5-7) may be utilized to determine OCV of the left earbud battery based on the corrected voltage of the left earbud battery and OCV of the right earbud battery based on the corrected voltage of the right earbud battery. Accordingly, state of charge (SOC) of the left earbud battery are calculated (e.g., according to FIG. 4) based on the corrected voltage of the left earbud battery and state of charge (SOC) of the right earbud battery are calculated based on the corrected voltage of the right earbud battery.

At 820, the method 800 includes determining whether a termination condition is satisfied. In some embodiments, the termination condition may include the SOC value achieving a pre-determined value (e.g., 100%). In this way, overcharging the earbud battery may be prevented by limiting the SOC value. In other embodiments, the termination condition may include both the right earbud and the left earbud being removed from the charging case prior to achieving the pre-determined value described above. For example, a user may remove the right earbud and the left earbud prior to the earbud battery achieving 100% SOC. Other embodiments may utilize additional or alternative termination conditions than described herein.

If the termination condition is not satisfied, the method 800 proceeds to 810 and includes determining total charge current via the charging case. If the termination condition is satisfied, the method 800 proceeds to 822 and includes terminating the charging mode. The charging mode may be terminated by ceasing the charge current to the left earbud and the right earbud via the charging case. By ceasing the charge current, the left earbud battery and the right earbud battery may cease charging. The method 800 then returns.

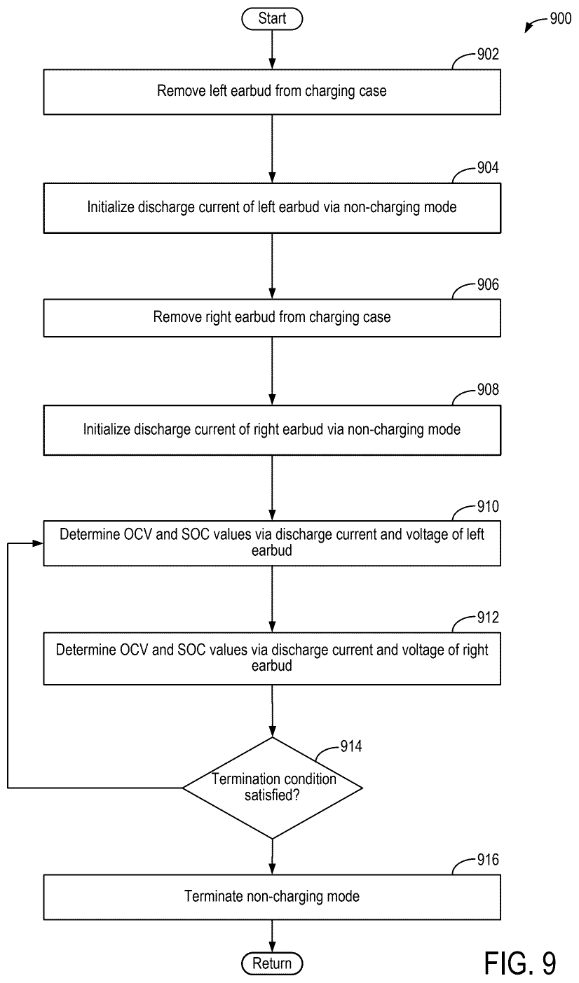

Turning to FIG. 9, a method 900 wherein a discharging scheme may be implemented to discharge an earbud battery of an earbud to perform the various functionalities of the wireless headphone. The non-charging mode may comprise one or more of a supplying a discharge current to the left earbud battery or to the right earbud battery, entering and maintaining a passive state, and a leakage current wherein a flow of current occurs during the passive state. The method 900 utilizes the control scheme 600 of FIG. 6 and the method 700 of FIG. 7 on a charging case of the wireless headphones, a left earbud of the wireless headphones, and a right earbud of the wireless headphones.

At 902, the method 900 includes removing the left earbud from the charging case. Prior to enabling a non-charging mode of the of the wireless headphones, a discharge current may be delayed to measure an initial left earbud battery voltage. In some embodiments, the delay may have a time duration of 3 seconds. Other embodiments of the present disclosure may utilize longer or shorter time durations for the delay. After the left earbud battery voltage is determined via a first analog to digital converter (ADC1) of the left earbud, the discharge current may be applied to the left earbud battery via the left earbud to discharge the left earbud battery. In various embodiment of the present disclosure, the left earbud may be removed from the charging case before, after, or at the same time as the right earbud. In the present example, the left earbud is removed from the charging case prior to the right earbud.

At 904, the method 900 includes initializing discharge current of left earbud via a non-charging mode. An initialization condition may be satisfied to initiate the discharge current of the left earbud during the non-charging mode. In some embodiments, the initialization condition may include a timer reaching a pre-determined time duration after the left earbud is removed from the charging case. The 3 second delay described above may satisfy this initialization condition. Other embodiments of the present disclosure may utilize an alternative initialization condition than described herein. For example, the initialization condition in other embodiments may include a sequence of events occurring after the left earbud is removed from the charging case. After the initialization condition is satisfied, the discharge current may be supplied to the left earbud, initializing the discharge current to begin discharging the left earbud battery. The discharge current is supplied to the left earbud battery a certain time period prior to the right earbud in the present example. Accordingly, the state of discharge (SOC) of the left earbud may be lower than that of the right earbud since the discharge current during the non-charging mode is supplied earlier.

At 906, the method 900 includes removing the right earbud from the charging case. After removing the right earbud, the charge current may be delayed to measure an initial earbud battery voltage of the right earbud. In some embodiments, the delay may have a time duration of 3 seconds. Other embodiments of the present disclosure may utilize longer or shorter time durations for the delay. After the right earbud battery voltage is determined via a first analog to digital converter (ADC) of the right earbud, the discharge current may be applied to the right earbud battery via the right earbud to discharge the right earbud battery. In various embodiment of the present disclosure, the right earbud may be removed from the charging case before, after, or at the same time as the left earbud. In the present example, the right earbud is removed from the charging case after the left earbud.

At 908, the method 900 includes initializing discharge current of right earbud via the non-charging mode. As described above with respect to the left earbud, the initialization condition may be satisfied to initiate the discharge current of the right earbud during the non-charging mode. The initialization condition for the left earbud and the right earbud may be the same in some embodiments. In other embodiments, the initialization condition may be different for the left earbud and the right earbud. After the initialization condition is satisfied, the discharge current may be supplied to the right earbud, initializing the discharge current to begin discharging the right earbud battery. As such, the discharge current is supplied to the left earbud battery for a certain time period prior to the right earbud in the present example. Accordingly, the state of discharge (SOC) of the right earbud may be higher than that of the left earbud since the discharge current during the non-charging mode is supplied later.

At 910, the method 900 includes determining OCV and SOC values via discharge current and voltage of the left earbud. As described herein, the OCV and SOC values of the left earbud may be determined according to the methods of FIGS. 4A-7 described herein. In particular, the instructions described with respect to FIG. 7 may be configured, stored, and executed in at least one memory of a Bluetooth chip or MCU in the left earbud. As such, the left earbud may determine the SOC of the left earbud battery. In this way, the left earbud may implement the instructions to determine SOC of the left earbud battery determining SOC values independently from the right earbud, and vice versa

At 912, the method 900 includes determining OCV and SOC value via discharge current and voltage of the right earbud. Similar to the left earbud, the OCV and SOC values of the right earbud may be determined according to the methods of FIGS. 4A-7 described herein. In particular, the instructions described with respect to FIG. 7 may be configured, stored, and executed in at least one memory of a Bluetooth chip or MCU in the right earbud. As such, the right earbud may determine the SOC of the right earbud battery. In this way, the right earbud may implement the instructions to determine SOC of the right earbud battery determining SOC values independently from the left earbud, and vice versa.

At 914, the method 900 includes determining whether a termination condition is satisfied. In some embodiments, the termination condition may include the SOC achieving a pre-determined value (e.g., 100%). In this way, over-discharging of the earbud battery may be prevented by limiting the SOC value. In other embodiments, the termination condition may include both the right earbud and the left earbud being inserted into the charging case prior to achieving the pre-determined value described above. For example, a user may insert the right earbud or the left earbud prior to the earbud battery achieving 0% SOC. Other embodiments may utilize additional or alternative termination conditions than described herein.

If the termination condition is not satisfied, the method 900 proceeds to 910 and includes determining OCV and SOC values of the left earbud via discharge current and voltage of left earbud. If the termination condition is satisfied, the method 900 proceeds to 916 and includes terminating the non-charging mode. The non-charging mode may be terminated by ceasing the discharge current to the left earbud and the right earbud. By ceasing the discharge current, the left earbud and the right earbud may cease discharging. The method 900 then returns.

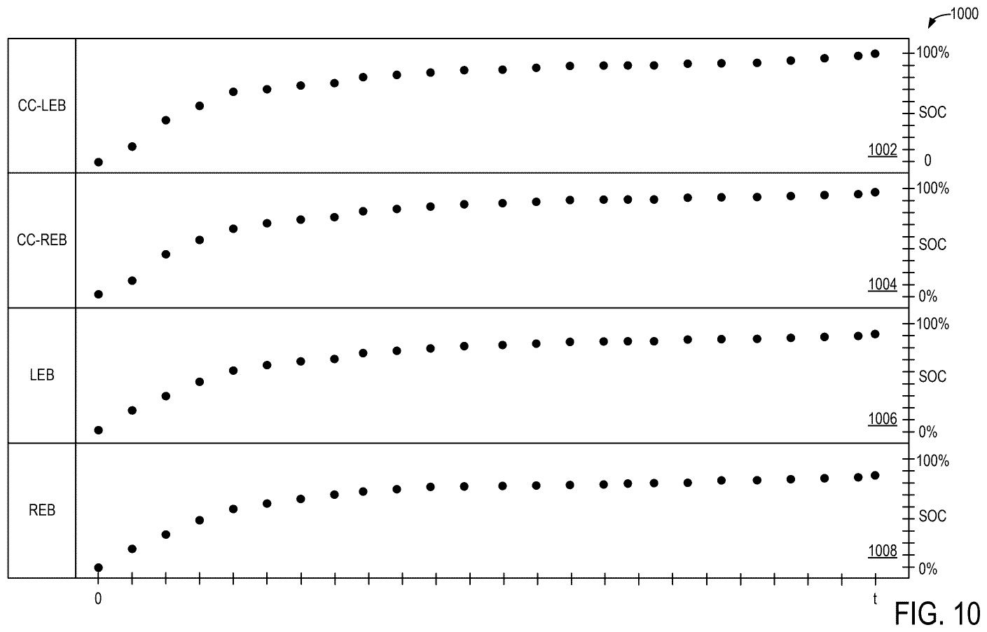

FIG. 10 illustrates a timing diagram 1000 wherein the state of charge (SOC) of a left earbud battery and a right earbud increases during a charging mode of wireless headphones. The charging mode may comprise supplying a charge current to a left earbud battery or to a right earbud battery. State of charge (SOC) of a left earbud battery LEB and a state of charge (SOC) of a right earbud battery REB is monitored by a charging case (e.g., CC-LEB and CC-REB), a left earbud, and a right earbud. In the present example, a left earbud is inserted into the charging case prior to the right earbud, and thus, the left earbud enters the charging mode prior to the right earbud.

The panel 1002 illustrates how SOC of the left earbud battery CC-LEB may vary in time while monitored by the charging case, the panel 1004 illustrates how SOC of the right earbud battery CC-REB may vary in time while monitored by the charging case, the panel 1006 illustrates how SOC of the left earbud battery LEB may vary in time while monitored by the left earbud, and the panel 1008 illustrates how SOC of the right earbud battery REB may vary in time while monitored by the right earbud. The state of charge (SOC) in the panel 1002, the panel 1004, the panel 1006, and the panel 1008 were determined according to the methods described herein.

The left earbud battery LEB and the right earbud battery REB have a state of charge (SOC) of 0% at time 0. As time increases, the state of charge of the left earbud battery LEB and the right earbud battery REB increase in panel 1002, panel 1004, panel 1006, and panel 1008. As described above, the left earbud entered the charging mode prior to the right earbud and the charge current is supplied to the left earbud battery LEB prior to the right earbud battery REB. As such, the state of charge of the left earbud battery LEB in panel 1002 and panel 1006 is larger at all points in time than the state of charge of the right earbud battery REB in panel 1004 and panel 1008 at all points in time.

In the timing diagram 1000, the SOC of the left earbud battery LEB at various points in time as determined by the charging case in panel 1002 is generally greater than the SOC of the left earbud battery LEB at various points in time as determined by the left earbud in panel 1006. Similarly, for the right earbud, the SOC of the right earbud battery REB at various points in time as determined by the charging case in panel 1004 is generally greater than the SOC of the right earbud battery REB at various points in time as determined by the right earbud in panel 1008. An earbud control system that does not account for the differences in SOC between the charging case and earbuds may result in inaccurate SOC readings for the left earbud battery and the right earbud battery. The current disclosure may adjust monitored parameters (e.g., charge current of an earbud battery) of the left earbud battery and right earbud battery according to the method 800 described in FIG. 8. In this way, the SOC determined by the charging case and the earbuds may be comparable.

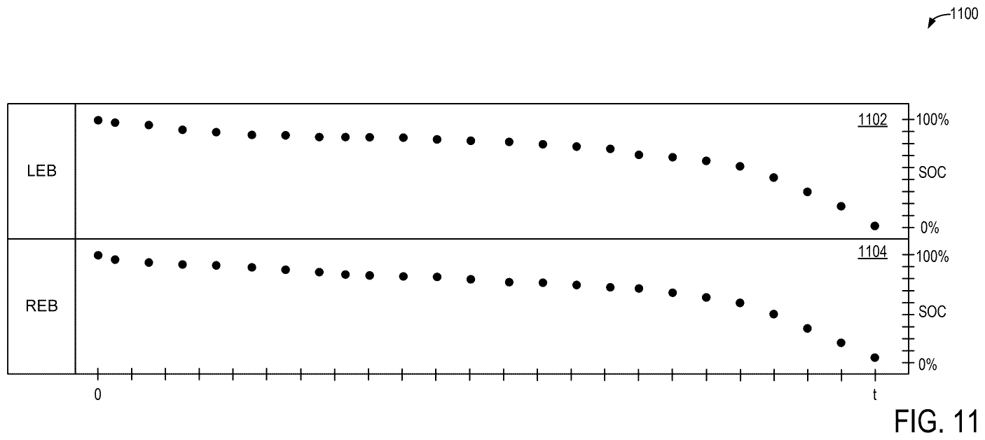

As shown in FIG. 11, a timing diagram 1100 wherein the state of charge (SOC) of a left earbud battery and a right earbud increases during a non-charging mode of wireless headphones. The non-charging mode may comprise one or more of a supplying a discharge current to the left earbud battery or to the right earbud battery, entering and maintaining a passive state, and a leakage current wherein a flow of current occurs during the passive state. State of charge (SOC) of a left earbud battery LEB and a state of charge (SOC) of a right earbud battery REB is monitored by a left earbud and a right earbud. In the present example, a left earbud is inserted into the charging case prior to the right earbud, and thus, the left earbud enters the non-charging mode prior to the right earbud.

The panel 1102 illustrates how SOC of the left earbud battery LEB may vary in time while monitored by the left earbud, and the panel 1004 illustrates how SOC of the right earbud battery REB may vary in time while monitored by the right earbud. The state of charge (SOC) in the panel 1002 and the panel 1004 were determined according to the methods described herein.

The SOC of left earbud battery LEB and the SOC of right earbud battery REB differ at time t=0. The SOC of the left earbud battery LEB is higher than the SOC of the right earbud battery REB at time t=0. In some embodiments, the SOC of the left earbud battery LEB may differ from the right earbud battery LEB due to either the left earbud battery LEB or the right earbud battery LEB entering a charging mode first. In this way, when the non-charging mode is entered, the SOC of the left earbud battery LEB may differ from the SOC of the right earbud battery REB.

As time increases, the state of charge of the left earbud battery and the right earbud battery decrease in panel 1002 and panel 1004. As described above, the left earbud entered the non-charging mode prior to the right earbud and the discharge current is supplied to the left earbud battery prior to the right earbud. As such, the final SOC of the left earbud battery LEB in panel 1002 is lower than the final SOC of the right earbud battery REB in panel 1004 despite the SOC of the right earbud battery REB having a smaller initial SOC than the SOC of the left earbud battery LEB.

The technical effect of simulating a fuel gauge IC via executable instructions to determine state of charge (SOC) of a left earbud battery via a left earbud or a charging case and state of charge (SOC) of a right earbud battery via a right earbud battery or the charging case is that more accurate monitoring of the SOC of the left earbud and the right earbud battery is achieved.

The disclosure also provides support for a method for an earbud battery of a wireless earbud, comprising: initializing a state of charge (SOC) of the earbud battery based on earbud battery voltage in response to transitioning from a non-charging mode to a charging mode of the wireless earbud. In a first example of the method, the charging mode comprises supplying a charge current to the wireless earbud to increase the SOC of the earbud battery, and the non-charging mode comprises at least one or more of supplying a discharge current to the wireless earbud to decrease the SOC of the earbud battery, and entering and maintaining a passive state of the wireless earbud, and experiencing a leakage current wherein the leakage current is a flow of current during the passive state. In a second example of the method, optionally including the first example, initializing the state of charge (SOC) of the earbud battery based on earbud battery voltage in response to transitioning from the non-charging mode to the charging mode of the wireless earbud comprises: satisfying an initialization condition, determining initial charging parameters, and supplying a charge current to the earbud battery.

In a third example of the method, optionally including one or both of the first and second examples, satisfying the initialization condition for the charging mode comprises the wireless earbud being inserted into a charging case and delaying the charge current being supplied to the wireless earbud for a pre-determined time duration to obtain initial charging parameters. In a fourth example of the method, optionally including one or more or each of the first through third examples, determining initial charging parameters comprises: approximating an initial open circuit voltage (OCV) for the wireless earbud, determining an initial state of charge (SOC) of the earbud battery, an initial temperature of the earbud battery, an initial sampling time, and an initial time constant, and calculating an initial coefficient based on the initial state of charge (SOC) of the earbud battery, the initial temperature of the earbud battery, and the initial time constant.

In a fifth example of the method, optionally including one or more or each of the first through fourth examples, the method further comprises: determining a temperature of the earbud battery and earbud battery voltage at a time K, modeling the earbud battery based on a first order resistor-capacitor (RC) circuit, calculating an open circuit voltage (OCV) of the earbud battery at the time K via a model equation and initial charging parameters, determining charging parameters at the time K wherein the charging parameters include a time, and a time constant, and a coefficient at the time K, and determining the state of charge (SOC) of the earbud battery based on pre-determined experimental data from pre-constructed state of charge-open circuit voltage (SOC-OCV) curves at the temperature of the earbud battery at time K. In a sixth example of the method, optionally including one or more or each of the first through fifth examples, the method further comprises: terminating the charging mode in response to the wireless earbud being removed from a charging case and entering the non-charging mode, and updating the state of charge (SOC) of the earbud battery.

The disclosure also provides support for a wireless headphone system, comprising: a left earbud comprising charging contacts to receive a charge current and docking magnets to mate with a charging case via a left cavity, a right earbud comprising charging contacts to receive the charge current and docking magnets to mate with the charging case via a right cavity, and the charging case comprising the left cavity with charging contacts to supply the charge current and docking magnets to mate the charging case with the left earbud, the right cavity with charging contacts to supply the charge current and docking magnets to mate the charging case with the right earbud, a charging case battery, and a microcontroller unit (MCU) comprising a processor and executable instructions in at least one memory, that when executed, cause the processor to: initialize a state of charge (SOC) of a left earbud battery based on earbud battery voltage in response to transitioning from a non-charging mode to a charging mode of the left earbud, and initialize a state of charge (SOC) of a right earbud battery based on earbud battery voltage in response to transitioning from the non-charging mode to the charging mode of the right earbud.

In a first example of the system, each of the left earbud and the right earbud further comprises: a microcontroller unit (MCU) or a Bluetooth chipset, an earbud battery, a first analog to digital converter, a second analog to digital converter communicatively coupled to a temperature sensor, a microphone that receives audio signals as input, a loudspeaker that processes audio signals and outputs sound, a plurality of integrated circuits wherein the plurality of integrated circuits power on the earbud, charge the earbud battery of the earbud, and protect the earbud battery, a light emitting diode (LED), a Bluetooth antenna, and an at least one communication bus to communicatively couple hardware components of the earbud. In a second example of the system, optionally including the first example, the charging mode comprises supplying the charge current via an integrated circuit of the plurality of integrated circuits to the left earbud to increase the state of charge (SOC) of the left earbud battery and to the right earbud to increase the state of charge (SOC) of the right earbud battery.

In a third example of the system, optionally including one or both of the first and second examples, initializing the state of charge (SOC) of the left earbud battery based on earbud battery voltage in response to transitioning from the non-charging mode to the charging mode of the left earbud comprises and initializing the state of charge (SOC) of the right earbud battery based on earbud battery voltage in response to transitioning from the non-charging mode to the charging mode of the right earbud comprises: delaying the charge current to each of the left earbud battery and the charge current to the right earbud for a pre-determined time duration, determining initial charging parameters of the left earbud battery at time t=0 independently from the initial charging parameters of the right earbud battery at time t=0, enabling the charging mode of the left earbud independently from the charging mode of the right earbud by supplying the charge current via the charging case, determining charging parameters of the left earbud battery at time t=K independently from the charging parameters of the right earbud battery at time t=K, determining an open circuit voltage (OCV) of the left earbud battery based on initial charging parameters at time t=0 and charging parameters at time t=K of the left earbud battery independently from an open circuit voltage (OCV) of the right earbud battery based on initial charging parameters at time t=0 and charging parameters at time t=K of the right earbud battery, determining state of charge (SOC) of the left earbud battery independently from state of charge (SOC) of the right earbud battery via pre-determined experimental data utilized to construct state of charge-open circuit voltage (SOC-OCV) curves, terminating the charging mode of the left earbud battery in response to removing the left earbud from the charging case and entering the non-charging mode of the left earbud battery independently from terminating the charging mode of the right earbud battery in response to removing the right earbud from the charging case and entering the non-charging mode of the right earbud battery, and updating the state of charge (SOC) of the left earbud battery based on SOC of the left earbud battery independently from the state of charge (SOC) of the right earbud battery based on SOC of the right earbud battery.

In a fourth example of the system, optionally including one or more or each of the first through third examples, delaying the charge current to each of the left earbud battery and right earbud battery for the pre-determined time duration comprises: not supplying the charge current to the left earbud and the right earbud via one of the plurality of integrated circuits via the charging case, determining initial charging parameters for the left earbud battery at time t=0 based on pre-determined experimental data, a temperature sensor of the left earbud battery, and voltage of the left earbud battery, and determining initial charging parameters for the right earbud battery at time t=0 based on pre-determined experimental data, a temperature sensor of the right earbud battery, and voltage of the right earbud battery. In a fifth example of the system, optionally including one or more or each of the first through fourth examples, charging parameters for each of the left earbud battery and the right earbud battery comprise: a temperature of an earbud battery at a particular point in time, a voltage of the earbud battery at the particular point in time, the open circuit voltage (OCV) of the earbud battery at the particular point in time, a sampling time Ts of the earbud battery, a time constant RC′ of the earbud battery, a coefficient α of the earbud battery based on the time constant RC′ and the sampling time Ts of the earbud battery.

In a sixth example of the system, optionally including one or more or each of the first through fifth examples, determining an open circuit voltage (OCV) of the left earbud battery and the right earbud battery via the charging case comprises: calculating an initial open circuit voltage (OCV) of the left earbud battery at time t=0 via a model equation and initial charging parameters of the left earbud battery and an initial open circuit voltage (OCV) of the right earbud battery at time t=0 via a model equation and initial charging parameters of the right earbud battery, determining a temperature of the left earbud battery via the temperature sensor of the left earbud and voltage of the left earbud battery via the charging case at time t=K, determining a temperature of the right earbud battery via the temperature sensor of the right earbud and voltage of the right earbud battery via the charging case at time t=K, estimating the state of charge (SOC) of the left earbud battery and the state of charge (SOC) of the right earbud battery at time t=K, determining charging parameters of the left earbud battery at time t=K based on an estimation of the state of charge (SOC) of the left earbud battery and the temperature of the left earbud battery at time t=K, determining the charging parameters of the left earbud battery at time t=K based on an estimation of the state of charge (SOC) of the right earbud battery and the temperature of the right earbud battery at time t=K, calculating a subsequent open circuit voltage (OCV) of the left earbud battery at a subsequent time via the model equation, the charging parameters at the subsequent time, and a previous open circuit voltage, and calculating a subsequent open circuit voltage (OCV) of the right earbud battery at a subsequent time via the model equation, the charging parameters at the subsequent time, and a previous open circuit voltage.

The disclosure also provides support for a wireless headphone system, comprising: a left earbud comprising a left earbud battery, at least one communication bus, a temperature sensor communicatively coupled to a first analog to digital converter of the left earbud, and a left Bluetooth chipset, a right earbud comprising a right earbud battery, at least one communication bus, a temperature sensor communicatively coupled to a first analog to digital converter of the right earbud, and a right Bluetooth chipset, and a charging case comprising at least one communication bus, a charging case battery, and a microcontroller unit (MCU) that comprises a processor and executable instructions in at least one memory, that when executed, cause the processor to: estimate total charge current flowing from the charging case battery via a model of the charging case battery, estimate left earbud battery charge current and right earbud battery charge current supplied to left earbud battery and right earbud battery via models of the left earbud battery and right earbud battery, respectively, apply a correction to state of charge of one or more of the charging case battery, left earbud battery, and right earbud battery based on difference between the estimate of total charge current and a sum of the left earbud battery charge current and right earbud battery charge current in response to charging both the left earbud battery and right earbud battery via the charging case, and not apply the correction when not charging both the left earbud battery and right earbud battery via the charging case battery during non-charging mode.

In a first example of the system, the charging case is communicatively coupled to the left earbud via the at least one communication bus of the charging case and the charging case is communicatively coupled to the right earbud via the at least one communication bus of the charging case. In a second example of the system, optionally including the first example applying the correction to state of charge (SOC) of one or more of the charging case battery, left earbud battery, and right earbud battery based on difference between the estimate of total charge current and the sum of the left earbud battery charge current and right earbud battery charge current in response to charging both the left earbud battery and right earbud battery via the charging case comprises: determining a current correction factor of the left earbud battery independently from the current correction factor of the right earbud battery, determining the current correction factor of the right earbud battery independently from the current correction factor of the left earbud battery and utilizing the current correction factor of the left earbud to determine a corrected voltage of the left earbud battery and the current correction factor of the right earbud to determine a corrected voltage of the right earbud battery.

In a third example of the system, optionally including one or both of the first and second examples, the corrected voltage of the left earbud battery is transmitted to the left Bluetooth chipset of the left earbud and the corrected voltage of the right earbud battery is transmitted to the right Bluetooth chipset of the right earbud via the at least one communication bus of the charging case. In a fourth example of the system, optionally including one or more or each of the first through third examples, an open circuit voltage (OCV) and state of charge (SOC) of the left earbud battery are calculated based on the corrected voltage of the left earbud battery and an open circuit voltage (OCV) and state of charge (SOC) of the right earbud battery are calculated based on the corrected voltage of the right earbud battery. In a fifth example of the system, optionally including one or more or each of the first through fourth examples, the current correction factor may be applied to adjust state of charge (SOC) of the left earbud battery determined by the charging case or the left earbud, and to adjust state of charge (SOC) of the right earbud battery determined by the charging case or the right earbud.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the circuitry shown in FIG. %. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for an earbud battery of a wireless earbud, comprising:
initializing a state of charge (SOC) of the earbud battery based on earbud battery voltage in response to transitioning from a non-charging mode to a charging mode of the wireless earbud.

2. The method of claim 1, wherein the charging mode comprises supplying a charge current to the wireless earbud to increase the SOC of the earbud battery, and the non-charging mode comprises at least one or more of supplying a discharge current to the wireless earbud to decrease the SOC of the earbud battery, and entering and maintaining a passive state of the wireless earbud, and experiencing a system leakage current wherein the leakage current is a flow of current during the passive state.

3. The method of claim 1, wherein initializing the state of charge (SOC) of the earbud battery based on earbud battery voltage in response to transitioning from the non-charging mode to the charging mode of the wireless earbud comprises:
satisfying an initialization condition for the charging mode;
determining initial charging parameters for the charging mode; and
supplying a charge current to the earbud battery during the charging mode.

4. The method of claim 3, wherein satisfying the initialization condition for the charging mode comprises the wireless earbud being inserted into a charging case and delaying the charge current being supplied to the wireless earbud for a pre-determined time duration to obtain initial charging parameters.

5. The method of claim 2, wherein determining initial charging parameters comprises:
approximating an initial open circuit voltage (OCV) for the wireless earbud;
determining an initial state of charge (SOC) of the earbud battery, an initial temperature of the earbud battery, an initial sampling time Tₛ, and an initial time constant RC′; and
calculating an initial coefficient α based on the initial state of charge (SOC) of the earbud battery, the initial temperature of the earbud battery, and the initial time constant RC′.

6. The method of claim 1, further comprising:
determining a temperature of the earbud battery and earbud battery voltage at a time K;
modeling the earbud battery based on a first order resistor-capacitor (RC) circuit;
calculating an open circuit voltage (OCV) of the earbud battery at the time K via a model equation and initial charging parameters;
determining charging parameters at the time K wherein the charging parameters include a time Tₛ, and a time constant RC′, and a coefficient α at the time K; and
determining the state of charge (SOC) of the earbud battery based on pre-determined experimental data from pre-constructed state of charge-open circuit voltage (SOC-OCV) curves at the temperature of the earbud battery at time K.

7. The method of claim 1, further comprising:
terminating the charging mode in response to the wireless earbud being removed from a charging case and entering the non-charging mode; and
updating the state of charge (SOC) of the earbud battery.

8. A wireless headphone system, comprising:
a left earbud comprising charging contacts to receive a charge current and docking magnets to mate with a charging case via a left cavity;
a right earbud comprising charging contacts to receive the charge current and docking magnets to mate with the charging case via a right cavity; and
the charging case comprising the left cavity with charging contacts to supply the charge current and docking magnets to mate the charging case with the left earbud, the right cavity with charging contacts to supply the charge current and docking magnets to mate the charging case with the right earbud, a charging case battery, and a microcontroller unit (MCU) comprising a processor and executable instructions in at least one memory, that when executed, cause the processor to:
initialize a state of charge (SOC) of a left earbud battery based on earbud battery voltage in response to transitioning from a non-charging mode to a charging mode of the left earbud; and
initialize a state of charge (SOC) of a right earbud battery based on earbud battery voltage in response to transitioning from the non-charging mode to the charging mode of the right earbud.

9. The system of claim 8, wherein each of the left earbud and the right earbud further comprises:
a microcontroller unit (MCU) or a Bluetooth chipset;
an earbud battery;
a first analog to digital converter;
a second analog to digital converter communicatively coupled to a temperature sensor;
a microphone that receives audio signals as input;
a loudspeaker that processes audio signals and outputs sound;
a plurality of integrated circuits wherein the plurality of integrated circuits power on the earbud, charge the earbud battery of the earbud, and protect the earbud battery;
a light emitting diode (LED);
a Bluetooth antenna; and
an at least one communication bus to communicatively couple hardware components of the earbud.

10. The system of claim 9, wherein the charging mode comprises supplying the charge current via an integrated circuit of the plurality of integrated circuits to the left earbud to increase the state of charge (SOC) of the left earbud battery and to the right earbud to increase the state of charge (SOC) of the right earbud battery.

11. The system of claim 9, wherein initializing the state of charge (SOC) of the left earbud battery based on earbud battery voltage in response to transitioning from the non-charging mode to the charging mode of the left earbud comprises and initializing the state of charge (SOC) of the right earbud battery based on earbud battery voltage in response to transitioning from the non-charging mode to the charging mode of the right earbud comprises:
delaying the charge current to each of the left earbud battery and the charge current to the right earbud for a pre-determined time duration;
determining initial charging parameters of the left earbud battery at time t=0 independently from the initial charging parameters of the right earbud battery at time t=0;
enabling the charging mode of the left earbud independently from the charging mode of the right earbud by supplying the charge current via the charging case;
determining charging parameters of the left earbud battery at time t=K independently from the charging parameters of the right earbud battery at time t=K;
determining an open circuit voltage (OCV) of the left earbud battery based on initial charging parameters at time t=0 and charging parameters at time t=K of the left earbud battery independently from an open circuit voltage (OCV) of the right earbud battery based on initial charging parameters at time t=0 and charging parameters at time t=K of the right earbud battery;
determining state of charge (SOC) of the left earbud battery independently from state of charge (SOC) of the right earbud battery via pre-determined experimental data utilized to construct state of charge-open circuit voltage (SOC-OCV) curves;
terminating the charging mode of the left earbud battery in response to removing the left earbud from the charging case and entering the non-charging mode of the left earbud battery independently from terminating the charging mode of the right earbud battery in response to removing the right earbud from the charging case and entering the non-charging mode of the right earbud battery; and
updating the state of charge (SOC) of the left earbud battery based on SOC of the left earbud battery independently from the state of charge (SOC) of the right earbud battery based on SOC of the right earbud battery.

12. The system of claim 11, wherein delaying the charge current to each of the left earbud battery and right earbud battery for the pre-determined time duration comprises:
not supplying the charge current to the left earbud and the right earbud via one of the plurality of integrated circuits via the charging case;
determining initial charging parameters for the left earbud battery at time t=0 based on pre-determined experimental data, a temperature sensor of the left earbud battery, and voltage of the left earbud battery; and
determining initial charging parameters for the right earbud battery at time t=0 based on pre-determined experimental data, a temperature sensor of the right earbud battery, and voltage of the right earbud battery.

13. The system of claim 11, wherein charging parameters for each of the left earbud battery and the right earbud battery comprise:
a temperature of an earbud battery at a particular point in time;
a voltage of the earbud battery at the particular point in time;
the open circuit voltage (OCV) of the earbud battery at the particular point in time;
a sampling time Tₛ of the earbud battery;
a time constant RC′ of the earbud battery;
a coefficient α of the earbud battery based on the time constant RC′ and the sampling time Tₛ of the earbud battery.

14. The system of claim 10, wherein determining an open circuit voltage (OCV) of the left earbud battery and the right earbud battery via the charging case comprises:
calculating an initial open circuit voltage (OCV) of the left earbud battery at time t=0 via a model equation and initial charging parameters of the left earbud battery and an initial open circuit voltage (OCV) of the right earbud battery at time t=0 via a model equation and initial charging parameters of the right earbud battery;
determining a temperature of the left earbud battery via a temperature sensor of the e left earbud battery and voltage of the left earbud battery via the charging case at time t=K;
determining a temperature of the right earbud battery via a temperature sensor of the right earbud battery and voltage of the right earbud battery via the charging case at time t=K;
estimating the state of charge (SOC) of the left earbud battery and the state of charge (SOC) of the right earbud battery at time t=K;
determining charging parameters of the left earbud battery at time t=K based on an estimation of the state of charge (SOC) of the left earbud battery and the temperature of the left earbud battery at time t=K;
determining the charging parameters of the left earbud battery at time t=K based on an estimation of the state of charge (SOC) of the right earbud battery and the temperature of the right earbud battery at time t=K;
calculating a subsequent open circuit voltage (OCV) of the left earbud battery at a subsequent time via the model equation, the charging parameters at the subsequent time, and a previous open circuit voltage; and
calculating a subsequent open circuit voltage (OCV) of the right earbud battery at a subsequent time via the model equation, the charging parameters at the subsequent time, and a previous open circuit voltage.

15. A wireless headphone system, comprising:
a left earbud comprising a left earbud battery, at least one communication bus, a temperature sensor communicatively coupled to a first analog to digital converter of the left earbud, and a left Bluetooth chipset;
a right earbud comprising a right earbud battery, at least one communication bus, a temperature sensor communicatively coupled to a first analog to digital converter of the right earbud; and a right Bluetooth chipset; and
a charging case comprising at least one communication bus, a charging case battery, and a microcontroller unit (MCU) that comprises a processor and executable instructions in at least one memory, that when executed, cause the processor to:
estimate total charge current flowing from the charging case battery via a model of the charging case battery;
estimate left earbud battery charge current and right earbud battery charge current supplied to left earbud battery and right earbud battery via models of the left earbud battery and right earbud battery, respectively;
apply a correction to state of charge of one or more of the charging case battery, left earbud battery, and right earbud battery based on difference between the estimate of total charge current and a sum of the left earbud battery charge current and right earbud battery charge current in response to charging both the left earbud battery and right earbud battery via the charging case; and
not apply the correction when not charging both the left earbud battery and right earbud battery via the charging case battery during non-charging mode.

16. The system of claim 15, wherein the charging case is communicatively coupled to the left earbud via the at least one communication bus of the charging case and the charging case is communicatively coupled to the right earbud via the at least one communication bus of the charging case.

17. The system of claim 15, applying the correction to state of charge (SOC) of one or more of the charging case battery, left earbud battery, and right earbud battery based on difference between the estimate of total charge current and the sum of the left earbud battery charge current and right earbud battery charge current in response to charging both the left earbud battery and right earbud battery via the charging case comprises:
determining a current correction factor of the left earbud battery independently from the current correction factor of the right earbud battery;
determining the current correction factor of the right earbud battery independently from the current correction factor of the left earbud battery; and
utilizing the current correction factor of the left earbud to determine a corrected voltage of the left earbud battery and the current correction factor of the right earbud to determine a corrected voltage of the right earbud battery.

18. The system of claim 17, wherein the corrected voltage of the left earbud battery is transmitted to the left Bluetooth chipset of the left earbud and the corrected voltage of the right earbud battery is transmitted to the right Bluetooth chipset of the right earbud via the at least one communication bus of the charging case.

19. The system of claim 17, wherein an open circuit voltage (OCV) and state of charge (SOC) of the left earbud battery are calculated based on the corrected voltage of the left earbud battery and an open circuit voltage (OCV) and state of charge (SOC) of the right earbud battery are calculated based on the corrected voltage of the right earbud battery.

20. The system of claim 17, wherein the current correction factor may be applied to adjust state of charge (SOC) of the left earbud battery determined by the charging case or the left earbud, and to adjust state of charge (SOC) of the right earbud battery determined by the charging case or the right earbud.
